(19) United States
(12) Patent Application Publication
(10) Pub. No.: US 2026/0255219 A1
(43) Pub. Date: Aug. 27, 2026

(54) COMMUNICATION APPARATUS, COMMUNICATION METHOD, AND COMMUNICATION SYSTEM

(71) Applicant: SONY GROUP CORPORATION, TOKYO (JP)

(72) Inventors: MITSUKI TAKAHASHI, TOKYO (JP); HIROKI MATSUDA, TOKYO (JP); SHINICHIRO TSUDA, TOKYO (JP); RYOTA KIMURA, TOKYO (JP)

(21) Appl. No.: 18/875,994

(22) PCT Filed: Jun. 14, 2023
(86) PCT No.: PCT/JP2023/022053

§ 371 Date: Dec. 17, 2024

(30) Foreign Application Priority Data
Jun. 22, 2022 (JP) 2022-100618

(51) Int. Cl. H04W 28/16; H04W 28/04; H04W 72/1273

(52) U.S. Cl. CPC H04W 28/16; H04W 28/04; H04W 72/1273

(57) ABSTRACT

A communication apparatus is a communication apparatus capable of performing communication using a plurality of transmission and reception points. The communication apparatus includes: a coder that generates a plurality of coded sequences from one transmission data sequence by using packet coding; and a generator that distributes the plurality of coded sequences for each transmission and reception point based on transport block size information of each of the plurality of transmission and reception points, and generate a transport block of each of the plurality of transmission and reception points based on the distributed coded sequence.

### FIELD

The present disclosure relates to a communication apparatus, a communication method, and a communication system.

### BACKGROUND

In recent years, cellular communications are under active development. For example, in recent years, there have been active developments of various forms of communications such as communication using a plurality of transmission and reception points (for example, multi-transmission and reception point (multi-TRP) ) and division of network functions (for example, division of base station functions).

### CITATION LIST

### Non Patent Literature

Non Patent Literature 1: 3GPP TSG-RAN, RP-202803, “Summary for WI: Enhancement on MIMO for NR”, Samsung
Non Patent Literature 2: 3GPP TSG-RAN WG2, R2-1914020 “LS on multi PDCCH-based and single PDCCH-based multi-TRP operation”
Non Patent Literature 3: 3GPP TS 38.401 V 16.8.0 (2021-12), 3rd Generation Partnership Project; Technical Specification Group Radio Access Network; NG-RAN; Architecture description (Release 16)

### Technical Problem

The complication of the communication mode may deteriorate communication performance (for example, reliability, low latency, or communication efficiency (for example, throughput or frequency utilization efficiency) ) of a communication apparatus or a communication system.

In view of this, the present disclosure proposes a communication apparatus, a communication method, and a communication system capable of achieving high communication performance.

Note that the above problem or target is merely one of a plurality of problems or targets that can be solved or achieved by a plurality of embodiments disclosed in the present specification.

### Solution to Problem

In order to solve the above problem, a communication apparatus according to the present embodiment that capable of performing communication using a plurality of transmission and reception points, the communication apparatus includes: a coder that generates a plurality of coded sequences from one transmission data sequence by using packet coding; and a generator that distributes the plurality of coded sequences for each transmission and reception point based on transport block size information of each of the plurality of transmission and reception points, and generate a transport block of each of the plurality of transmission and reception points based on the distributed coded sequence.

### BRIEF DESCRIPTION OF DRAWINGS

FIG. 1 is a diagram illustrating a network configuration that can be adopted by a communication system according to the present embodiment.

FIG. 2 is a diagram illustrating a functional configuration example of a communication system according to an embodiment of the present disclosure.

FIG. 3 is a diagram illustrating a configuration example of a server according to an embodiment of the present disclosure.

FIG. 4 is a diagram illustrating a configuration example of a management apparatus according to the embodiment of the present disclosure.

FIG. 5 is a diagram illustrating a configuration example of a base station according to the embodiment of the present disclosure.

FIG. 6 is a diagram illustrating a configuration example of a terminal apparatus according to the embodiment of the present disclosure.

FIG. 7 is a diagram illustrating an outline of packet coding processing executed by a communication apparatus on a transmission side.

FIG. 8 is a diagram illustrating an outline of packet coding processing executed by a communication apparatus on a reception side.

FIG. 9 is a diagram for illustrating packet coding processing.

FIG. 10 is a diagram illustrating an example of redundant data assigned to a coded bit sequence.

FIG. 11 is a diagram illustrating an example of a coding procedure of packet coding processing.

FIG. 12 is a diagram illustrating an example of a coding procedure of a plurality of received coded bit sequences.

FIG. 13 is a sequence diagram illustrating an exemplary procedure of packet coding processing.

FIG. 14 is a diagram illustrating a first mode of multi-TRP.

FIG. 15 is a diagram illustrating a second mode of the multi-TRP.

FIG. 16 is a diagram illustrating an example of an NG RAN architecture.

FIG. 17 is a diagram illustrating an outline of transmission processing according to a first embodiment.

FIG. 18 is a diagram illustrating an outline of reception processing according to the first embodiment.

FIG. 19 is a sequence diagram illustrating transmission/reception processing according to the first embodiment.

FIG. 20 is a sequence diagram illustrating transmission/reception processing according to the first embodiment.

FIG. 21 is a diagram for illustrating a boundary line between a CU and a DU.

FIG. 22 is a diagram illustrating an example of an IAB architecture (C-plane).

FIG. 23 is a diagram illustrating an example of an architecture of a gNB in a state in which a CP and an UP are separated.

FIG. 24 is a diagram illustrating an example of a basic mode of a network configuration.

FIG. 25 is a diagram illustrating an example of a basic mode of a network configuration.

FIG. 26 is a diagram illustrating an example of an architecture that can be adopted by the HU.

FIG. 27 is a diagram illustrating an exemplary architecture that can be adopted by the MU and the RU.

FIG. 28 is a diagram illustrating an exemplary architecture that can be adopted by the MU and the RU.

FIG. 29 is a diagram illustrating an exemplary architecture that can be adopted by the MU and the RU.

FIG. 30 is a diagram illustrating a communication architecture assumed in the present embodiment.

FIG. 31 is a diagram illustrating a communication architecture assumed in the present embodiment.

FIG. 32 is a diagram illustrating a communication architecture assumed in the present embodiment.

FIG. 33 is a diagram illustrating a communication architecture assumed in the present embodiment.

FIG. 34 is a flowchart illustrating transmission processing according to a second embodiment.

FIG. 35 is a flowchart illustrating reception processing according to a second embodiment.

### DESCRIPTION OF EMBODIMENTS

Embodiments of the present disclosure will be described below in detail with reference to the drawings. Note that, in each of the following embodiments, the same parts are denoted by the same reference symbols, and a repetitive description thereof will be omitted.

Moreover, in the present specification and the drawings, a plurality of components having substantially the same functional configuration will be distinguished by attaching different numbers after the same reference numerals. For example, a plurality of configurations having substantially the same functional configuration are distinguished as necessary, such as terminal apparatuses 401, 402, and 403. However, when it is not particularly necessary to distinguish between the plurality of components having substantially the same functional configuration, only the same reference numeral is given. For example, in a case where it is not necessary to particularly distinguish the terminal apparatuses 401, 402, and 403, they are simply referred to as the terminal apparatus 40.

One or more embodiments (including examples and modifications) described below can each be implemented independently. On the other hand, at least some of the multiple embodiments described below may be appropriately combined with at least some of other embodiments. The plurality of embodiments may include novel features different from each other.

Accordingly, the plurality of embodiments can contribute to achieving or solving different objects or problems, and can exhibit different effects.

### 1. Overview

Radio access technologies (RAT) such as Long Term Evolution (LTE) and New Radio (NR) have been studied in the 3rd Generation Partnership Project (3GPP). LTE and NR are a type of cellular communication technology, and enable mobile communication of terminal apparatuses by using cellular arrangement of a plurality of areas covered by base stations (or a transmission and reception point (TRP) ). At this time, one base station (or one TRP) may manage a plurality of cells, and a plurality of base stations (or TRPs) may be included in a single base station.

In the following, it is assumed that “LTE” includes LTE-Advanced (LTE-A), LTE-Advanced Pro (LTE-A Pro), and Evolved Universal Terrestrial Radio Access (E-UTRA). In addition, it is assumed that NR includes New Radio Access Technology (NRAT) and Further E-UTRA (FE-UTRA). In the following, a cell corresponding to LTE may be referred to as an LTE cell, and a cell corresponding to NR may be referred to as an NR cell. The base station in LTE may be referred to as evolved Node B (eNodeB). The base station in NR may be referred to as gNodeB. In LTE and NR, a terminal apparatus (also referred to as a mobile station, mobile station device, or terminal) may be referred to as user equipment (UE).

NR is a radio access technology (RAT) as next generation (fifth generation) following LTE. The NR is a radio access technology that can support various use cases including enhanced mobile broadband (eMBB), massive machine type communications (mMTC), and Ultra-Reliable and Low Latency Communications (URLLC). NR is being studied with the aim of creating a technical framework that supports usage scenarios, requirements, and deployment scenarios for these use cases.

For example, in recent years, there have been active developments of various forms of communications such as communication using a plurality of transmission and reception points (for example, multi-transmission and reception point (multi-TRP) ) and division of network functions (for example, division of base station functions into a Central Unit (CU and a Distributed Unit (DU). The complication of the communication mode may deteriorate communication performance (such as reliability, low latency, or frequency utilization efficiency, for example) of the communication apparatus or the communication system.

For example, in communication using a plurality of transmission and reception points, there is a case where an appropriate transport block is not generated due to a difference in a transport block size for each transmission and reception point, decreasing communication efficiency. In addition, dividing a network function might lead to a failure in data decoding processing by an appropriate apparatus due to complication of the network configuration, decreasing communication efficiency or communication reliability.

In view of this, the present embodiment (including first and second embodiments) is provided to solve the above problem as follows.

### First Embodiment

In the first embodiment, a communication system includes: a transmission apparatus (for example, a base station) capable of performing communication using a plurality of transmission and reception points; and a reception apparatus (for example, a terminal apparatus) capable of performing communication using a plurality of transmission and reception points.

The transmission apparatus generates a plurality of coded sequences from one transmission data sequence by using packet coding. Subsequently, the transmission apparatus distributes the plurality of coded sequences for each transmission and reception point based on transport block size information of each of the plurality of transmission and reception points, and generates a transport block of each of the plurality of transmission and reception points based on the distributed coded sequence.

The reception apparatus receives a plurality of transport blocks from the transmission apparatus. Subsequently, the reception apparatus decodes the plurality of coded sequences extracted from the plurality of transport blocks using a decoding method corresponding to packet coding.

This makes it possible for the communication system of the first embodiment to cope with a case where the transport block size is different for each transmission and reception point, leading to improvement in communication efficiency.

### Second Embodiment

The second embodiment assumes that a configuration of a network connected to User Equipment (UE) is functionally split into a Higher Unit (HU) indicating a unit of a highest layer, a Radio Unit (RU) indicating a unit of a lowest layer, and a Middle Unit (MU) indicating a unit located in the middle of the HU and the RU.

The communication system of the second embodiment includes: a transmission apparatus corresponding to the HU; and a reception apparatus corresponding to the MU, the RU, or the UE.

The transmission apparatus acquires information related to an RU having direct connection with an edge MU which is an MU located closest to the RU, from the edge MU. Based on the information related to the RU acquired from the edge MU, information related to architecture regarding the edge MU, the RU, and the UE is determined. Subsequently, the transmission apparatus generates a plurality of coded sequences from one transmission data sequence by using packet coding. Subsequently, the transmission apparatus assigns information related to architecture to the plurality of coded sequences.

Th reception apparatus receives, from the transmission apparatus (HU), the coded sequence to which information related to the architecture is assigned, and determines whether decoding processing is valid or invalid based on the information related to the architecture assigned to the coded sequence. When the decoding processing is determined to be valid, the reception apparatus decodes the plurality of coded sequences using a decoding method corresponding to packet coding.

With this configuration, the communication system of the second embodiment can perform decoding processing by an appropriate apparatus on the network, making it possible to improve communication efficiency or communication reliability.

The outline of the present embodiment (first and second embodiments) has been described above. Hereinafter, a communication system according to the present embodiment will be described in detail.

### 2. Configuration of Communication System Hereinafter, a configuration of a communication system 1 will be specifically described with reference to the drawings.

The configuration of the communication system 1 described below is common to the first and second embodiments.

### 2-1. Network Configuration Examples

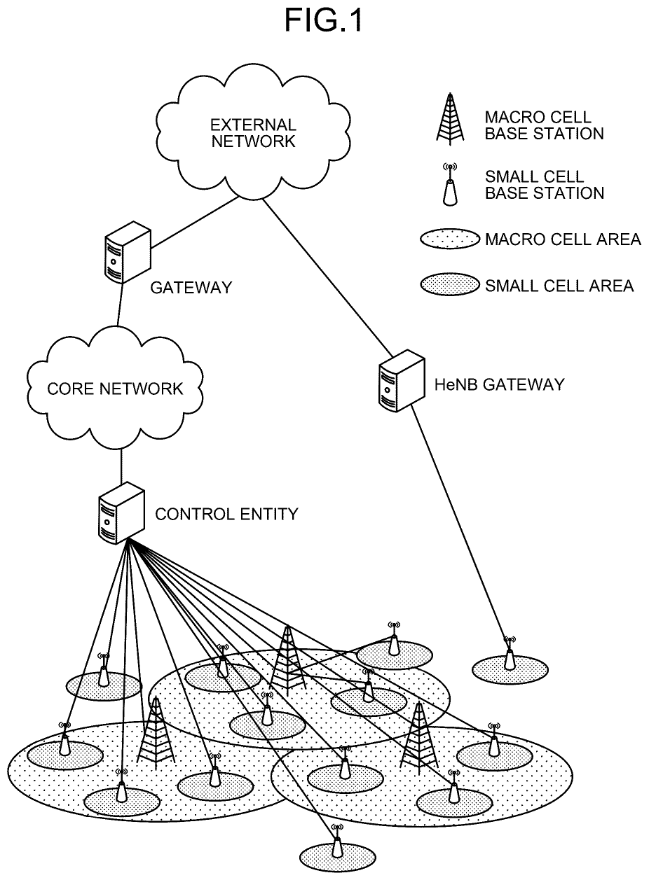

FIG. 1 is a diagram illustrating a network configuration that can be adopted by a communication system 1 of the present embodiment (first and second embodiments). A line (broken line) in the drawing denotes logical connection, and does not necessarily indicate direct physical connection. A communication area is constituted by a “cell” (an ellipse in the drawing) that receives a service from each of a plurality of base stations. One base station may provide service to a plurality of cells. The base stations can communicate with each other via a backhaul (regardless of whether the communication is made in wired or wireless connection), and mainly exchange control information.

An assumable example of the communication using the backhaul is communication using a protocol of an X2 interface or an S1 interface.

The base station also has a backhaul with the core network of the system. At that time, the base station may be connected to the core network by connecting to a control entity (the control entity may be regarded as one element of the core network). Furthermore, the base station may be connected to the core network via an external network in addition to the control entity. Examples of the base station to be connected include a femto cell base station device or an HeNB device that can be installed indoors or at home.

Similarly, when base station function split is implemented and base stations are defined as separate units, these units may have a midhaul between the units. These units may be connected to the core network by being individually connected to the control entity or the core network. In addition, these units may be connected to the control entity or the core network by relaying between the same or different units generated by function split.

When base station function split is implemented, and base stations are defined as separate units, the units may be shared by a same or separate base stations or by apparatuses or entities that constitute macro cells or micro cells.

When base station function split is implemented, and base stations are defined as separate units, these units do not necessarily need to be physically separated from each other. These units may be defined by virtual or logical separation.

The midhaul may be physically or logically established. At this time, the midhaul may be constituted by a dedicated communication path or a general public network. Alternatively, the midhaul may be established via a wireless device. In addition, the midhaul and the backhaul may overlap each other.

Furthermore, a device or a base station constituting the macro cell or the micro cell may have a fronthaul between a unit including at least the RF device or the antenna device and other functions or devices. At this time, the fronthaul allows any connection regardless of whether the connection is physical, logical, wireless, wired, dedicated line, or general network.

The apparatus constituting the small cell or the femto cell may be constituted by a unit including at least an RF apparatus or an antenna apparatus. These units may be shared by one or a plurality of base stations or some device with similar functions.

The small cell area is basically disposed so as to overlap with the macro cell area. However, the small cell area may be disposed partially or entirely outside of the macro cell area.

A device constituting a macro cell, a device constituting a small cell, or a device having a base station function may have a feature in a radio resource to be used. For example, a same frequency resource F1 (or a time resource T1) may be used in the macro cell and the small cell. This makes it possible to improve the radio resource utilization efficiency of the entire system. On the other hand, the macro cell may use the frequency resource F1 (or the time resource T1), and the small cell may use a frequency F2 (or a time resource T2). This makes it possible to avoid interference between the macro cell and the small cell. Furthermore, both types of cells or devices having a base station function may use F½ (T½). This is a concept equivalent to carrier aggregation (CA) when applied to frequency resources.

A macro cell and a device having a small cell or a base station function may be characterized by a radio resource to be used or a superimposition method thereof on the premise of each being spatially separated from each other. Examples include Multi Input Multi Output (MIMO) and Spatial Division Multiplex using beamforming.

The macro cell and the small cell may include a plurality of transmission and reception points or a plurality of radio transmitters/receivers. In communication using a plurality of transmission and reception points or a plurality of radio transmitters-receivers, the plurality of transmission and reception points and the plurality of radio transmitters-receivers may use separate resources (frequency and time) or may use the same resources at the time of transmission/reception. The plurality of transmission and reception points and the plurality of radio transmitters-receivers may be shared and used by different cells.

### <2-2. Functional Configuration Example of Communication System

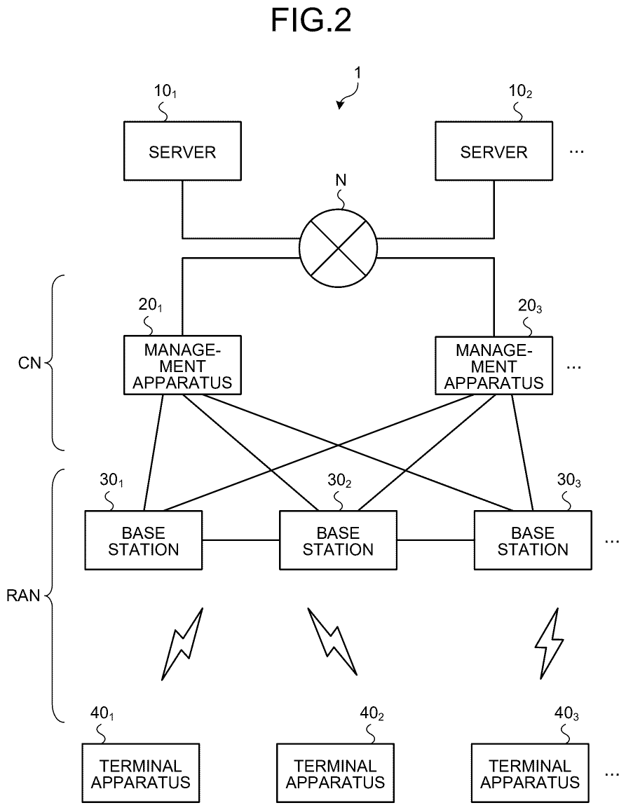

FIG. 2 is a diagram illustrating a functional configuration example of the communication system 1 according to the embodiment of the present disclosure. The communication system 1 includes a server 10, a management apparatus 20, a base station 30, and a terminal apparatus 40. With individual wireless communication apparatuses constituting the communication system 1 operating in cooperation with each other, the communication system 1 provides a user with a wireless network capable of mobile communication. The wireless network of the present embodiment includes a radio access network and a core network, for example. In the present embodiment, the wireless communication apparatus is an apparatus having a wireless communication function, and in the example of FIG. 2, the apparatus corresponds to the base station 30 and the terminal apparatus 40.

The communication system 1 may include a plurality of servers 10, a plurality of management apparatuses 20, a plurality of base stations 30, and a plurality of terminal apparatuses 40. In the example of FIG. 2, the communication system 1 includes servers 101, 102, and so on as the server 10, and includes management apparatuses 201, 202 and so on as the management apparatus 20. In the example of FIG. 2, the communication system 1 includes base stations 301, 302, and so on as the base station 30, and includes terminal apparatuses 401 402, 403 and so on as the terminal apparatus 40. The server 10 is connected to the management apparatus 20 via a network N. The server 10 may be connected to an apparatus other than the management apparatus 20, such as the terminal apparatus 40, via the network N.

Examples of the network N include communication networks such as a local area network (LAN), a wide area network (WAN), a cellular network, a fixed-line telephone network, a regional Internet protocol (IP) network, and the Internet. The network N may include a wired network or a wireless network. The network N may unquestionably be a data network connected to the core network. The data network may be a service network of a telecommunications carrier, for example, an IP Multimedia Subsystem (IMS) network. Furthermore, the data network may be a private network such as an intranet. Although only one network is illustrated in the example of FIG. 2, the number of networks is not limited to one.

The device in the figure may be considered as a device in a logical sense. That is, parts of the device in the drawing may be partially actualized by a virtual machine (VM), a container, a docker, or the like, and they may be implemented on physically the same piece of hardware.

The communication system 1 may be compatible with a radio access technology (RAT) such as long term evolution (LTE) and new radio (NR). LTE and NR are a type of cellular communication technology, and enable mobile communication of terminal apparatuses by using cellular arrangement of a plurality of areas covered by base stations.

The radio access method used by the communication system 1 is not limited to LTE and NR, and may be other radio access methods such as wideband code division multiple access (W-CDMA) and code division multiple access 2000 (cdma 2000), for example.

Furthermore, the base station or the relay station constituting the communication system 1 may be a terrestrial station or a non-terrestrial station. The non-terrestrial station may be a satellite station or an aircraft station. If the non-terrestrial station is a satellite station, the communication system 1 may be a Bent-pipe (Transparent) mobile satellite communication system.

In the present embodiment, the terrestrial station (also referred to as a terrestrial base station) refers to a base station (a relay station) installed on the ground. The “ground” represents not only a land but also a terrestrial location in a broad sense including underground, above-water, and underwater. Note that, in the following description, the description of “terrestrial station” may be referred to as a “gateway”.

The base station in LTE may be referred to as Evolved Node B (eNodeB) or eNB. NR base stations may be referred to as gNodeB or gNB. In LTE and NR, a terminal apparatus (also referred to as a mobile station, or terminal) may be referred to as user equipment (UE). The terminal apparatus is a type of communication apparatus, and is also referred to as a mobile station or a terminal.

In the present embodiment, the concept of the “communication apparatus” includes not only a portable mobile device (terminal apparatus) such as a mobile terminal but also a device installed in a structure or a mobile body. The structure or a mobile body itself may be regarded as a communication apparatus. In addition, the concept of the communication apparatus includes not only a terminal apparatus but also a base station and a relay station. The communication apparatus is a type of processing apparatus and information processing apparatus. The communication apparatus can be paraphrased as a transmission apparatus or a reception apparatus.

Hereinafter, configurations of individual devices included in the communication system 1 will be specifically described. The configuration of each device illustrated below is just an example. The configuration of each device may differ from the configuration below.

### 2-3. Configuration of Server

First, a configuration of the server 10 will be described.

The server 10 is an information processing apparatus (computer) that provides various services to the terminal apparatus 40 via the network. For example, the server 10 may be an application server or a web server. The server 10 may be a PC server, a midrange server, or a mainframe server. The server 10 may be an information processing apparatus that performs data processing (edge processing) near the user or the terminal. For example, the server 10 may be an information processing apparatus (computer) provided close to or built in a base station. The server 10 may naturally be an information processing apparatus that performs cloud computing.

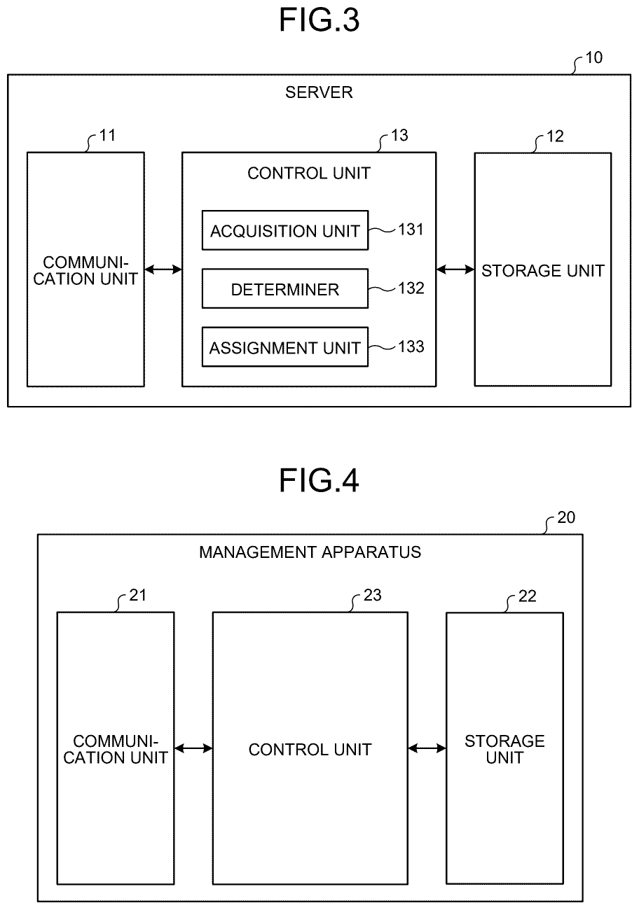

FIG. 3 is a diagram illustrating a configuration example of the server 10 according to the embodiment of the present disclosure. The server 10 includes a communication unit 11, a storage unit 12, and a control unit 13. Note that the configuration illustrated in FIG. 4 is a functional configuration, and the hardware configuration may be different from this. Furthermore, the functions of the server 10 may be installed in a distributed manner in a plurality of physically separated configurations. For example, the server 10 may include a plurality of information processing apparatuses.

The communication unit 11 is a communication interface for communicating with other apparatuses. For example, the communication unit 11 is a network interface. An example of the communication unit 11 is a local area network (LAN) interface such as a Network Interface Card (NIC). The communication unit 11 may be a wired interface, or may be a wireless interface. The communication unit 11 functions as a communication means of the server 10. The communication unit 11 communicates with the terminal apparatus 40 under the control of the control unit 13.

The storage unit 12 is a data readable/writable storage device such as dynamic random access memory (DRAM), static random access memory (SRAM), a flash drive, or a hard disk. The storage unit 12 functions as a storage means of the server 10. The storage unit 12 stores, for example, a prediction model (learning model) to be distributed to the terminal apparatus 40, such as a quality prediction model and an intention prediction model. These pieces of information will be described below.

The control unit 13 is a controller that controls individual units of the server 10. The control unit 13 is implemented by a processor such as a central processing unit (CPU) or a micro processing unit (MPU), for example. For example, the control unit 13 is implemented by execution of various programs stored in the storage device inside the server 10 by the processor using random access memory (RAM) or the like as a work area. Note that the control unit 13 may be implemented by an integrated circuit such as an application specific integrated circuit (ASIC) or a field programmable gate array (FPGA). The CPU, MPU, ASIC, and FPGA can all be regarded as controllers.

As illustrated in FIG. 3, the control unit 13 includes an acquisition unit 131, a determiner 132, and an assignment unit 133. Individual blocks (the acquisition unit 131 to the assignment unit 133) constituting the control unit 13 are functional blocks individually indicating functions of the control unit 13. These functional blocks may be software blocks or hardware blocks. For example, each of the functional blocks described above may be one software module realized by software (including a microprogram) or one circuit block on a semiconductor chip (die). Each of the functional blocks may naturally be formed as one processor or one integrated circuit.

The functional block may be configured by using any method. Note that the control unit 13 may be configured in a functional unit different from the above-described functional block.

The operation of the control unit 23 may be the same as the operation of each block of the control unit 33 of the base station 30, or may be the same as the operation of each block of the control unit 43 of the terminal apparatus 40.

### 2-4. Configuration of Management Apparatus

Next, a configuration of the management apparatus 20 will be described.

The management apparatus 20 is an apparatus that manages a wireless network. For example, the management apparatus 20 is an apparatus that manages communication of the base station 30. The management apparatus 20 may be an apparatus having a function as a Mobility Management Entity (MME). The management apparatus 20 may be an apparatus having a function as an Access and Mobility Management Function (AMF) and/or a Session Management Function (SMF). Understandably, the functions of the management apparatus 20 are not to be limited to the MME, the AMF, or the SMF. The management apparatus 20 may be an apparatus having a function as a Network Slice Selection Function (NSSF), an Authentication Server Function (AUSF), a Policy Control Function (PCF), or Unified Data Management (UDM). Furthermore, the management apparatus 20 may be an apparatus having a function as a Home Subscriber Server (HSS).

Note that the management apparatus 20 may have a function of a gateway. For example, the management apparatus 20 may have a function as a Serving Gateway (S-GW) or a Packet Data Network Gateway (P-GW). Furthermore, the management apparatus 20 may have a function as a User Plane Function (UPF).

The core network includes a plurality of network functions. Each network function may be integrated into one physical device or distributed to a plurality of physical devices. That is, the management apparatus 20 can be disposed in a plurality of apparatuses as distributed arrangement. Furthermore, this distributed arrangement may be controlled to be performed dynamically. The base station 30 and the management apparatus 20 constitute one network, and provide a wireless communication service to the terminal apparatus 40. The management apparatus 20 is connected to the Internet, and the terminal apparatus 40 can use various services provided over the Internet via the base station 30.

Note that the management apparatus 20 does not necessarily have to be an apparatus constituting a core network. For example, it is assumed that the core network is a core network of Wideband Code Division Multiple Access (W-CDMA) or Code Division Multiple Access 2000 (cdma 2000). At this time, the management apparatus 20 may be an apparatus that functions as a Radio Network Controller (RNC).

FIG. 4 is a diagram illustrating a configuration example of the management apparatus 20 according to an embodiment of the present disclosure. The management apparatus 20 includes a communication unit 21, a storage unit 22, and a control unit 23. Note that the configuration illustrated in FIG. 4 is a functional configuration, and the hardware configuration may be different from this. Furthermore, the functions of the management apparatus 20 may be implemented in a statically or dynamically distributed form in a plurality of physically separated configurations. For example, the management apparatus 20 may be constituted with a plurality of server devices.

The communication unit 21 is a communication interface for communicating with other devices. The communication unit 21 may be a network interface or a device connection interface. For example, the communication unit 21 may be a local area network (LAN) interface such as a network interface card (NIC), or may be a universal serial bus (USB) interface including a USB host controller, a USB port, and the like. Furthermore, the communication unit 21 may be a wired interface or a wireless interface. The communication unit 21 functions as a communication means of the management apparatus 20. The communication unit 21 communicates with the base station 30 and the like under the control of the control unit 23.

The storage unit 22 is a data readable/writable storage device such as dynamic random access memory (DRAM), static random access memory (SRAM), a flash drive, or a hard disk. The storage unit 22 functions as a storage means in the management apparatus 20. The storage unit 22 stores, for example, a connection state of the terminal apparatus 40. For example, the storage unit 22 stores a Radio Resource Control (RRC) state or an EPS connection management (ECM) state or a 5G system connection management (CM) state of the terminal apparatus 40. The storage unit 22 may function as a unit referred to as “home memory” that stores location information of the terminal apparatus 40.

The control unit 23 is a controller that controls individual components of the management apparatus 20. The control unit 23 is implemented by a processor such as a central processing unit (CPU), a micro processing unit (MPU), or a graphics processing unit (GPU), for example. For example, the control unit 23 is actualized by execution of various programs stored in the storage device inside the management apparatus 20 by the processor using random access memory (RAM) or the like as a work area. Note that the control unit 23 may be implemented by an integrated circuit such as an application specific integrated circuit (ASIC) or a field programmable gate array (FPGA). The CPU, MPU, GPU, ASIC, and FPGA can all be regarded as controllers.

Note that the operation of the control unit 23 may be the same as the operation of each block of the control unit 13 of the server 10. The operation of the control unit 23 may be the same as the operation of each block of the control unit 33 of the base station 30, or may be the same as the operation of each block of the control unit 43 of the terminal apparatus 40.

### 2-5. Configuration of Base Station

Next, a configuration of the base station 30 will be described.

The base station 30 is a wireless communication apparatus that performs wireless communication with the terminal apparatus 40. The base station 30 may be configured to perform wireless communication with the terminal apparatus 40 via another base station 30, or may be configured to directly perform wireless communication with the terminal apparatus 40.

The base station 30 is a type of communication apparatus. More specifically, the base station 30 is a device corresponding to a radio base station (Base Station, Node B, eNB, gNB, etc.) or a radio access point. The base station 30 may be a radio relay station. Furthermore, the base station 30 may be an optical link device referred to as a Remote Radio Head (RRH) or a Radio Unit (RU). Furthermore, the base station 30 may be a receiving station such as a Field Pickup Unit (FPU). In addition, the base station 30 may be an Integrated Access and Backhaul (IAB) donor node or an IAB relay node that provides a radio access channel and a radio backhaul channel by using time division multiplexing, frequency division multiplexing, or space division multiplexing.

In a case where the base station 30 is an IAB donor node, the base station 30 may operate as an IAB-Central Unit (IAB-CU). Furthermore, in a case where the base station 30 is an IAB relay node, the base station 30 may operate as IAB-mobile termination (IAB-MT) for an IAB donor node that provides backhaul, and may operate as an IAB-distributed unit (IAB-DU) for the terminal apparatus 40 that provides access.

Note that the radio access technology used by the base station 30 may be a cellular communication technology or a wireless LAN technology. Understandably, the radio access technology used by the base station 30 is not limited thereto, and may be other radio access technologies. For example, the radio access technology used by the base station 30 may be a low power wide area (LPWA) communication technology. Understandably, the wireless communication used by the base station 30 may be wireless communication using millimeter waves. Furthermore, the wireless communication used by the base station 30 may be wireless communication using radio waves or wireless communication (optical wireless communication) using infrared rays or visible light.

The base station 30 may be capable of Non-Orthogonal Multiple Access (NOMA) communication with the terminal apparatus 40. Here, NOMA communication refers to communication (transmission, reception, or both) using non-orthogonal resources. The base station 30 may be capable of performing NOMA communication with another base station 30.

The base station 30 may be capable of communicating with each other via a base station-core network interface (for example, NG Interface, SI Interface, or the like). This interface may be implemented as wired or wireless interface. Furthermore, the base stations may be capable of communicating with each other via an inter-base station interface (for example, Xn Interface, X2 Interface, S1 Interface, F1 Interface, or the like). This interface may be implemented as wired or wireless interface.

Note that the concept of the base station includes not only a donor base station but also a relay base station (also referred to as a relay station). For example, the relay base station may be any one of RF Repeater, Smart Repeater, and Intelligent Surface. Furthermore, a base station conceptually includes not only a structure having a function of a base station but also a device installed in the structure.

Examples of the structure include a building such as a high-rise building, a house, a steel tower, a station facility, an airport facility, a harbor facility, an office building, a school building, a hospital, a factory, a commercial facility, or a stadium. The concept of the structure includes not only buildings but also non-building structures such as tunnels, bridges, dams, fences, and steel columns, as well as facilities such as cranes, gates, and windmills. In addition, a structure conceptually includes not only land-based (ground-based, in a narrow sense) structures or underground structures but also structures on the water, such as a jetty and a mega-float, and underwater structures such as an ocean observation facility. The base station may be referred to as an information processing apparatus.

The base station 30 may be a donor station or a relay station. The base station 30 may be a fixed station or a mobile station. The mobile station is a wireless communication apparatus (for example, a base station) configured to be movable. At this time, the base station 30 may be an apparatus installed on a mobile body, or may be a mobile body itself. For example, a relay station having mobility can be regarded as the base station 30 as a mobile station. In addition, an apparatus designed to have mobility, such as an Unmanned Aerial Vehicle (UAV) represented by a drone, or a smartphone, and having a function of a base station (at least a part of the function of a base station) also corresponds to the base station 30 as a mobile station.

Here, the mobile body may be a mobile terminal such as a smartphone or a mobile phone. The mobile body may be a mobile body that moves on the land (ground in a narrow sense) (for example, a vehicle such as an automobile, a motorcycle, a bus, a truck, a motorbike, a train, or a linear motor car), or a mobile body (for example, subway) that moves under the ground (for example, through a tunnel). The mobile body may be a mobile body that moves on the water (for example, a ship such as a passenger ship, a cargo ship, and a hovercraft), or a mobile body that moves underwater (for example, a submersible ship such as a submersible boat, a submarine, or an unmanned submarine). The mobile body may be a mobile body that moves in the atmosphere (for example, an aircraft such as an airplane, an airship, or a drone).

Furthermore, the base station 30 may be a terrestrial base station (terrestrial station) installed on the ground. For example, the base station 30 may be a base station disposed on a structure on the ground, or may be a base station installed in a mobile body moving on the ground. More specifically, the base station 30 may be an antenna installed in a structure such as a building and a signal processing device connected to the antenna. Note that the base station 30 may be a structure or a mobile body itself. The “ground” represents not only a land (ground in a narrow sense) but also a terrestrial location in a broad sense including underground, above-water, and underwater.

Note that the base station 30 is not limited to a terrestrial base station. For example, in a case where the communication system 1 is a satellite communication system, the base station 30 may be an aircraft station. From the perspective of a satellite station, an aircraft station located on the earth is a terrestrial station.

Note that the base station 30 is not limited to a terrestrial station. The base station 30 may be a non-terrestrial base station (non-terrestrial station) capable of floating in the air or space. For example, the base station 30 may be an aircraft station or a satellite station.

The satellite station is a satellite station capable of floating outside the atmosphere. The satellite station may be an apparatus mounted on a space mobile body such as an artificial satellite, or may be a space mobile body itself. A space mobile body is a mobile body that moves outside the atmosphere. Examples of the space mobile body include artificial bodies such as artificial satellites, spacecraft, space stations, and probes.

The satellite serving as the satellite station may be any of a low earth orbiting (LEO) satellite, a medium earth orbiting (MEO) satellite, a geostationary earth orbiting (GEO) satellite, or a highly elliptical orbiting (HEO) satellite. Accordingly, the satellite station may be a device mounted on a low earth orbiting satellite, a medium earth orbiting satellite, a geostationary earth orbiting satellite, or a highly elliptical orbiting satellite.

The aircraft station is a wireless communication apparatus capable of floating in the atmosphere, such as an aircraft. The aircraft station may be a device mounted on an aircraft or the like, or may be an aircraft itself. The concept of the aircraft includes not only heavy aircraft such as an airplane and a glider but also light aircraft such as a balloon and an airship. In addition, the concept of the aircraft includes not only a heavy aircraft and a light aircraft but also a rotorcraft such as a helicopter and an auto-gyro. Note that the aircraft station (or an aircraft on which an aircraft station is mounted) may be an unmanned aerial vehicle such as a drone.

Note that the concept of the unmanned aerial vehicle also includes an unmanned aircraft system (UAS) and a tethered UAS. The concept of unmanned aerial vehicles also includes a Lighter-than-Air (LTA) unmanned aircraft system (UAS) and a Heavier-than-Air (HTA) unmanned aircraft system (UAS). Other concepts of unmanned aircraft also include High Altitude Platforms (HAPs) unmanned aircraft system (UAS).

The coverage of the base station 30 may be large such as a macro cell or small such as a pico cell. Understandably, the coverage of the base station 30 may be extremely small such as a femto cell. Furthermore, the base station 30 may have a beamforming capability. In this case, the base station 30 may form a cell or a service area for each beam.

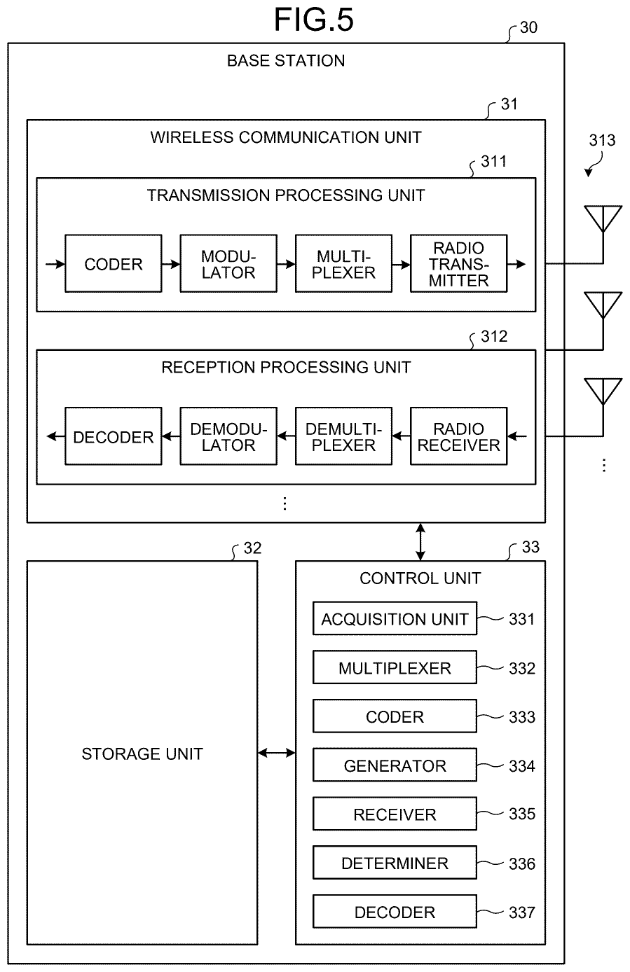

FIG. 5 is a diagram illustrating a configuration example of the base station 30 according to the embodiment of the present disclosure. The base station 30 includes a wireless communication unit 31, a storage unit 32, and a control unit 33. The configuration illustrated in FIG. 5 is a functional configuration, and the hardware configuration may be different from this. Furthermore, the functions of the base station 30 may be implemented in a distributed form in a plurality of physically separated configurations.

The wireless communication unit 31 is a signal processing unit for performing wireless communication with other wireless communication apparatuses (for example, the terminal apparatus 40). The wireless communication unit 31 operates under the control of the control unit 33. The wireless communication unit 31 may support one or a plurality of radio access methods. For example, the wireless communication unit 31 supports both NR and LTE. The wireless communication unit 31 may support W-CDMA or cdma 2000 in addition to NR and LTE. The wireless communication unit 31 may support an automatic retransmission technology such as Hybrid Automatic Repeat reQuest (HARQ).

The wireless communication unit 31 includes a transmission processing unit 311, a reception processing unit 312, and an antenna 313. The wireless communication unit 31 may include a plurality of the transmission processing units 311, a plurality of the reception processing units 312, and a plurality of the antennas 313. In a case where the wireless communication unit 31 supports a plurality of radio access methods, individual portions of the wireless communication unit 31 can be configured separately for each of the radio access methods. For example, the transmission processing unit 311 and the reception processing unit 312 may be separately configured for LTE and NR. Furthermore, the antenna 313 may include a plurality of antenna elements (for example, a plurality of patch antennas). In this case, the wireless communication unit 31 may be configured to be capable of beamforming. The wireless communication unit 31 may be configured to be able to perform polarization beamforming using vertically polarized waves (V-polarized waves) and horizontally polarized waves (H-polarized waves).

The transmission processing unit 311 performs transmission processing of downlink control information and downlink data. The transmission processing unit 311 codes the downlink control information and the downlink data input from the control unit 33 by using a coding scheme such as block coding, convolutional coding, or turbo coding. The coding may perform coding using a polar code or a Low Density Parity Check (LDPC) code. The transmission processing unit 311 modulates the coded bits by a predetermined modulation scheme such as BPSK, QPSK, 16 QAM, 64 QAM, or 256 QAM. In this case, the signal points on the constellation do not necessarily have to be equidistant. The constellation may be a non-uniform constellation (NUC). The transmission processing unit 311 multiplexes the modulation symbol of each of channels and the downlink reference signal and allocates the multiplexed signals on a predetermined resource element. Subsequently, the transmission processing unit 311 performs various types of signal processing on the multiplexed signal. For example, the transmission processing unit 311 performs processing such as conversion to the frequency domain using fast Fourier transform, addition of a guard interval (cyclic prefix), generation of a baseband digital signal, conversion to an analog signal, quadrature modulation, upconvert, removal of extra frequency components, and power amplification. The signal generated by the transmission processing unit 311 is transmitted from the antenna 313.

The reception processing unit 312 processes an uplink signal received via the antenna 313. For example, the reception processing unit 312 performs processing on the uplink signal, such as down-conversion, removal of unnecessary frequency components, amplification level control, orthogonal demodulation, conversion to digital signal, removal of guard interval (cyclic prefix), and frequency domain signal extraction using fast Fourier transform. The reception processing unit 312 Subsequently demultiplexes an uplink channel such as a physical uplink shared channel (PUSCH) or a physical uplink control channel (PUCCH) and an uplink reference signal from the signal that has undergone these processing procedures. Subsequently, the reception processing unit 312 demodulates a received signal using a modulation scheme such as binary phase shift keying (BPSK) or quadrature phase shift keying (QPSK) for the modulation symbol of the uplink channel. The modulation scheme used in the demodulation may be 16 quadrature amplitude modulation (QAM), 64 QAM, or 256 QAM. In this case, the signal points on the constellation do not necessarily have to be equidistant. The constellation may be a non-uniform constellation (NUC). Subsequently, the reception processing unit 312 performs decoding processing on the coded bits of the demodulated uplink channel. The decoded uplink data and uplink control information are output to the control unit 33.

The antenna 313 is an antenna device (antenna unit) that performs mutual conversion of a current and a radio wave. The antenna 313 may include one antenna element (for example, one patch antenna) or may include a plurality of antenna elements (for example, a plurality of patch antennas). In a case where the antenna 313 includes a plurality of antenna elements, the wireless communication unit 31 may be configured to be capable of beamforming. For example, the wireless communication unit 31 may control the directivity of a radio signal using a plurality of antenna elements to generate a directional beam. The antenna 313 may be a dual polarized antenna. When the antenna 313 is a dual polarized antenna, the wireless communication unit 31 may use a vertically polarized wave (V polarized wave) and a horizontally polarized wave (H polarized wave) when transmitting radio signals. Subsequently, the wireless communication unit 31 may control the directivity of the radio signal transmitted using the vertically polarized wave and the horizontally polarized wave. Furthermore, the wireless communication unit 31 may transmit and receive spatially multiplexed signals via a plurality of layers including a plurality of antenna elements.

The storage unit 32 is a data readable/writable storage device such as DRAM, SRAM, a flash drive, and a hard disk. The storage unit 32 functions as a storage means in the base station 30.

The control unit 33 is a controller that controls individual components of the base station 30. The control unit 33 is implemented by a processor such as a central processing unit (CPU) or a micro processing unit (MPU), for example. For example, the control unit 33 is implemented by execution of various programs stored in the storage device inside the base station 30 by the processor using random access memory (RAM) or the like as a work area. Note that the control unit 33 may be implemented by an integrated circuit such as an application specific integrated circuit (ASIC) or a field programmable gate array (FPGA). The CPU, MPU, ASIC, and FPGA can all be regarded as controllers. Furthermore, the control unit 33 may be implemented by a graphics processing unit (GPU) in addition to or instead of the CPU.

The control unit 33 includes an acquisition unit 331, a multiplexer 332, a coder 333, a generator 334, a receiver 335, a determiner 336, and a decoder 337. Individual blocks (the acquisition unit 331 to the decoder 337) constituting the control unit 33 are functional blocks individually indicating functions of the control unit 33. These functional blocks may be software blocks or hardware blocks. For example, each of the functional blocks described above may be one software module realized by software (including a microprogram) or one circuit block on a semiconductor chip (die). Each of the functional blocks may naturally be formed as one processor or one integrated circuit. Note that the control unit 33 may be configured in a functional unit different from the above-described functional block. The functional block may be configured by using any method.

The operation of the control unit 23 may be the same as the operation of each block (the acquisition unit 131 to the assignment unit 133) of the control unit 13 of the server 10, or may be the same as the operation of each block of the control unit 43 of the terminal apparatus 40.

In some embodiments, the concept of a base station may be constituted with a collection of a plurality of physical or logical devices. For example, in the present embodiment, the base station may be classified into a plurality of devices such as a Baseband Unit (BBU) and a Radio Unit (RU). The base station may be interpreted as an assembly of the plurality of devices. In addition, the base station may be either or both of a BBU and an RU. The BBU and the RU may be connected by a predetermined interface (for example, an enhanced Common Public Radio Interface (eCPRI) ). The RU may be referred to as a Remote Radio Unit (RRU) or a Radio DOT (RD). The RU may correspond to a gNB Distributed Unit (gNB-DU) described below. The BBU may correspond to a gNB Central Unit) (gNB-CU) described below.

Alternatively, the RU may be a wireless device connected to a gNB-DU described below. The gNB-CU, the gNB-DU, and the RU connected to the gNB-DU may be configured to conform to an Open Radio Access Network (O-RAN). The RU may be a device integrally formed with an antenna. An antenna (for example, an antenna integrally formed with an RU) included in the base station may adopt an Advanced Antenna System and support MIMO (for example, FD-MIMO) or beamforming. For example, the antenna included in the base station may include 64 transmitting antenna ports and 64 receiving antenna ports.

In addition, the antenna mounted on the RU may be an antenna panel including one or more antenna elements, and the RU may include one or more antenna panels. For example, the RU may include two types of antenna panels of a horizontally polarized antenna panel and a vertically polarized antenna panel, or two types of antenna panels of a clockwise (right-hand) circularly polarized antenna panel and a counterclockwise (left-hand) circularly polarized antenna panel. In addition, the RU may form and control an independent beam for each antenna panel.

The plurality of base stations may be connected to each other. One or the plurality of base stations may be included in a Radio Access Network (RAN). That is, the base station may be simply referred to as a RAN, a RAN node, an Access Network (AN), or an AN node. RAN in LTE may be referred to as Enhanced Universal Terrestrial RAN (EUTRAN). In addition, RAN in NR may be referred to as NGRAN. RAN in W-CDMA (UMTS) may be referred to as UTRAN.

The base station in LTE may be referred to as Evolved Node B (eNodeB) or eNB. That is, EUTRAN includes one or a plurality of eNodeB (eNB). NR base stations may be referred to as gNodeB or gNB. At this time, NGRAN contains one or a plurality of gNBs. EUTRAN may include gNB (en-gNB) connected to the core network (EPC) in LTE communication systems (EPS). Similarly, NGRAN may include an ng-eNB connected to the core network 5GC in a 5G communication system (5GS).

When the base station is eNB, gNB, or the like, the base station may be referred to as 3GPP access. Furthermore, when the base station is a radio access point, the base station may be referred to as non-3GPP access. The base station may be an optical link device referred to as a Remote Radio Head (RRH) or a Radio Unit (RU). Furthermore, in a case where the base station is a gNB, the base station may be a combination of the gNB-CU and the gNB-DU described above, or may be any one of the gNB-CU and the gNB-DU.

Here, in order to have a communication with the UE, the gNB-CU hosts a plurality of upper layers (for example, Radio Resource Control (RRC), Service Data Adaptation Protocol (SDAP), and Packet Data Convergence Protocol (PDCP)) in an access stratum. On the other hand, the gNB-DU hosts a plurality of lower layers (for example, Radio Link Control (RLC), Medium Access Control (MAC), and Physical Layer (PHY)) in an access stratum. That is, among messages/information to be described below, RRC signaling (semi-static notification) may be generated by the gNB-CU, while MAC CE and DCI (dynamic notification) may be generated by the gNB-DU. Alternatively, among the RRC configurations (semi-static notifications), some configurations such as IE: cellGroupConfig may be generated by the gNB-DU, while the remaining configurations may be generated by the gNB-CU, for example. These configurations may be transmitted and received through an F1 interface described below.

The base station may be configured to be able to communicate with another base station. For example, when a plurality of base stations is eNB each or a combination of eNBs and en-gNBs, the base stations may be connected to each other by an X2 interface. Furthermore, when a plurality of base stations is gNB each or a combination of gn-eNB and gNB, the devices may be connected to each other by an Xn interface. Furthermore, when a plurality of base stations is a combination of gNB CU and gNB DU, the devices may be connected to each other by the F1 interface described above. The message/information (for example, RRC signaling, MAC control element (MAC CE), or DCI) described below may be transmitted between a plurality of base stations via the X2 interface, the Xn interface, or the F1 interface, for example.

The cell provided by the base station may be referred to as a serving cell. The serving cell conceptually includes a primary cell (PCell) and a secondary cell (SCell). When dual connectivity is configured for the UE (for example, the terminal apparatus 40), the PCell provided by a Master Node (MN) and zero or one or more SCells may be referred to as a Master Cell Group. Examples of dual connectivity include EUTRA-EUTRA Dual Connectivity, EUTRA-NR Dual Connectivity (ENDC), EUTRA-NR Dual Connectivity with 5GC, NR-EUTRA Dual Connectivity (NEDC), and NR-NR Dual Connectivity.

The serving cell may include a Primary Secondary Cell or Primary SCG Cell (PSCell). In a case where dual connectivity is configured in the UE, the PSCell and the zero or one or more SCells provided by a secondary node (SN) may be referred to as Secondary Cell Group (SCG). Unless specially configured (for example, PUCCH on SCell), a physical uplink control channel (PUCCH) is transmitted in the PCell and the PSCell, but is not transmitted in the SCell. In addition, a radio link failure is also detected in the PCell and the PSCell, but is not detected in the SCell (need not be detected). In this manner, since the PCell and the PSCell have a special role in the serving cell, these cells are also referred to as Special Cells (SpCells).

One cell may be associated with one downlink component carrier and one uplink component carrier. In addition, the system bandwidth corresponding to one cell may be divided into a plurality of bandwidth parts (BWPs). In this case, one or a plurality of BWPs may be configured for the UE, and one BWP may be used for the UE as an active BWP. In addition, radio resources (for example, a frequency band, a numerology (subcarrier spacing), and a slot format (slot configuration)) usable by the terminal apparatus 40 may be different for each cell, each component carrier, or each BWP.

### 2-6. Configuration of Terminal Apparatus

Next, a configuration of the terminal apparatus 40 will be described.

The terminal apparatus 40 is a wireless communication apparatus that performs wireless communication with other communication apparatuses such as the base station 30. Examples of the terminal apparatus 40 include a mobile phone, a smart device (smartphone or tablet), a personal digital assistant (PDA), or a personal computer. Furthermore, the terminal apparatus 40 may be a device such as a business camera equipped with a communication function, or may be a motorcycle, a moving relay vehicle, or the like on which communication equipment such as a field pickup unit (FPU) is mounted. The terminal apparatus 40 may be a machine to machine (M2M) device or an Internet of Things (IoT) device.

The terminal apparatus 40 may be capable of performing NOMA communication with the base station 30. The terminal apparatus 40 may be able to use an automatic retransmission technology such as HARQ when communicating with the base station 30. The terminal apparatus 40 may be capable of sidelink communication with another terminal apparatus 40. The terminal apparatus 40 may be capable of using the automatic retransmission technology such as HARQ also at the time of performing sidelink communication. The terminal apparatus 40 may also be capable of NOMA communication in the communication (sidelink) with another terminal apparatus 40. Furthermore, the terminal apparatus 40 may be capable of LPWA communication with other communication apparatuses (for example, the base station 30 or another terminal apparatus 40). In addition, the wireless communication used by the terminal apparatus 40 may be wireless communication using millimeter waves. The radio communication (including sidelink communication) used by the terminal apparatus 40 may be radio communication using radio waves or wireless communication (optical wireless communication) using infrared rays or visible light.

Furthermore, the terminal apparatus 40 may be a mobile device. The mobile device is a movable wireless communication apparatus. At this time, the terminal apparatus 40 may be a wireless communication apparatus installed on a mobile body, or may be the mobile body itself. For example, the terminal apparatus 40 may be a vehicle that moves on a road, such as an automobile, a bus, a truck, or a motorbike, may be a vehicle traveling on a rail installed in the track of a train or the like, or may be a wireless communication apparatus mounted on the vehicle. The mobile body may be a mobile terminal, or may be a mobile body that moves on land (on the ground in a narrow sense), in the ground, on water, or under water. Furthermore, the mobile body may be a mobile body that moves inside the atmosphere, such as a drone or a helicopter, or may be a mobile body that moves outside the atmosphere, such as an artificial satellite.

The terminal apparatus 40 may perform communication while being simultaneously connected to a plurality of base stations or a plurality of cells. For example, when one base station supports a communication area via a plurality of cells (for example, pCell and sCell), it is possible to aggregate the plurality of cells and communicate between the base station 30 and the terminal apparatus 40 by using a carrier aggregation (CA) technology, a dual connectivity (DC) technology, or a multi-connectivity (MC) technology. Alternatively, the terminal apparatus 40 and the plurality of base stations 30 can communicate with each other by a Coordinated Multi-Point Transmission and Reception (COMP) technology via cells of different base stations 30.

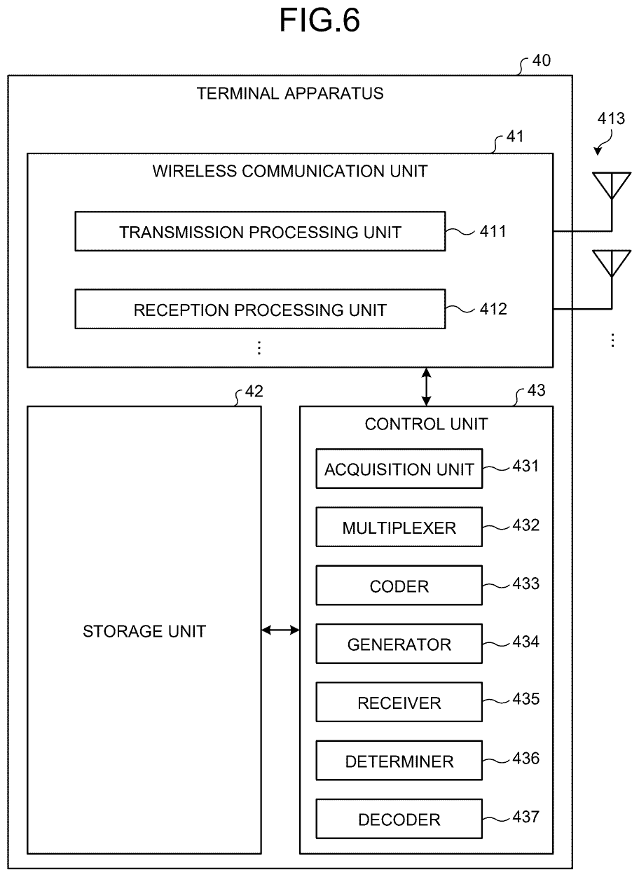

FIG. 6 is a diagram illustrating a configuration example of the terminal apparatus 40 according to the embodiment of the present disclosure. The terminal apparatus 40 includes a wireless communication unit 41, a storage unit 42, and a control unit 43. Note that the configuration illustrated in FIG. 6 is a functional configuration, and the hardware configuration may be different from this. Furthermore, the functions of the terminal apparatus 40 may be implemented in a distributed manner in a plurality of physically separated configurations.

The wireless communication unit 41 is a signal processing unit for performing wireless communication with other wireless communication apparatuses (for example, the base station 30 and another terminal apparatus 40). The wireless communication unit 41 operates under the control of the control unit 43. The wireless communication unit 41 includes a transmission processing unit 411, a reception processing unit 412, and an antenna 413. The configurations of the wireless communication unit 41, the transmission processing unit 411, the reception processing unit 412, and the antenna 413 may be similar to the configurations of the wireless communication unit 31, the transmission processing unit 311, the reception processing unit 312, and the antenna 313 of the base station 30, respectively. The wireless communication unit 41 may be configured to be capable of beamforming similarly to the wireless communication unit 31. Furthermore, similarly to the wireless communication unit 31, the wireless communication unit 41 may be capable of transmitting and receiving spatially multiplexed signals.

The storage unit 42 is a data readable/writable storage device such as DRAM, SRAM, a flash drive, and a hard disk. The storage unit 42 functions as a storage means in the terminal apparatus 40.

The control unit 43 is a controller that controls individual parts of the terminal apparatus 40. The control unit 43 is actualized by a processor such as a CPU or an MPU, for example. For example, the control unit 43 is implemented by a processor executing various programs stored in a storage device inside the terminal apparatus 40 using RAM or the like as a work area. The control unit 43 may be actualized by an integrated circuit such as an ASIC or an FPGA. The CPU, MPU, ASIC, and FPGA can all be regarded as controllers. The control unit 43 may be implemented by a GPU in addition to or instead of the CPU.

The control unit 43 includes an acquisition unit 431, a multiplexer 432, a coder 433, a generator 434, a receiver 435, a determiner 436, and a decoder 437. Individual blocks (the acquisition unit 431 to the decoder 437) constituting the control unit 43 are functional blocks individually indicating functions of the control unit 43. These functional blocks may be software blocks or hardware blocks. For example, each of the functional blocks described above may be one software module realized by software (including a microprogram) or one circuit block on a semiconductor chip (die). Each of the functional blocks may naturally be formed as one processor or one integrated circuit. Note that the control unit 43 may be configured in a functional unit different from the above-described functional block. The functional block may be configured by using any method.

The operation of the control unit 43 may be the same as the operation of each block (the acquisition unit 131 to the assignment unit 133) of the control unit 13 of the server 10, or may be the same as the operation of each block (the acquisition unit 331 to the decoder 337) of the control unit 33 of the base station 30.

### 3. Packet Coding

The configuration of the communication system 1 of the present embodiment has been described above. Next, packet coding as a premise of transmission/reception processing of the present embodiment will be described.

### 3-1. Overview of Packet Coding

The present embodiment uses a coding technique of generating a plurality of coded bit sequences from one information sequence (or a plurality of bit sequences generated by dividing one information sequence) to be transmitted. This coding method is referred to as packet coding in the present embodiment.

In the following description, a plurality of bit sequences generated by dividing one information sequence (also referred to as one transmission data sequence) may be referred to as a plurality of source bit sequences or a plurality of subsequences. In the following description, a coded bit sequence generated by packet coding may be referred to as a coded bit sequence or a coded sequence. Furthermore, in the following description, not only the processing of generating a plurality of coded bit sequences from one information sequence (or a plurality of source bit sequences) (coding processing) but also the processing of generating one information sequence (or a plurality of source bit sequences) from a plurality of coded bit sequences (decoding processing) may be referred to as packet coding processing.

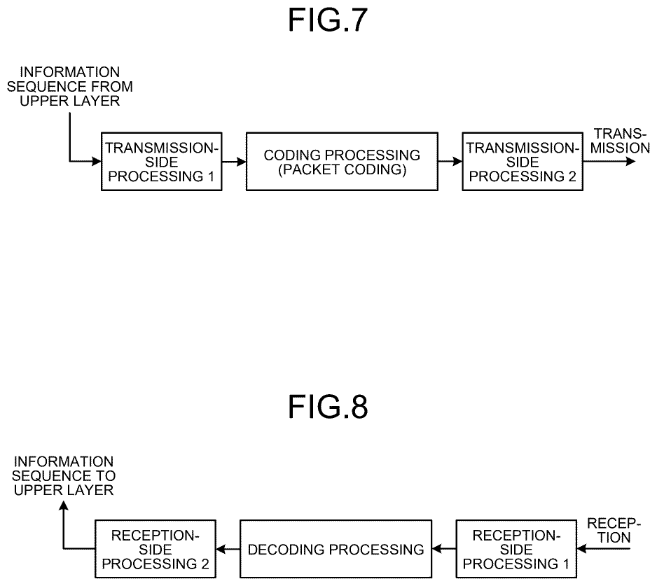

FIGS. 7 and 8 are diagrams illustrating an outline of packet coding processing. Specifically, FIG. 7 is a diagram illustrating an outline of packet coding processing executed by a communication apparatus on the transmission side, and FIG. 8 is a diagram illustrating an outline of packet coding processing executed by a communication apparatus on the reception side.

Both the base station 30 and the terminal apparatus 40 can be communication apparatuses on the transmission side or the reception side. In the present embodiment, the communication apparatus applies packet coding processing to an information sequence to be transmitted and received.

First, processing on the transmission side will be described with reference to FIG. 7. First, when having acquired an information sequence from an upper layer (for example, an SDAP layer or an RRC layer), a predetermined layer related to signal processing inside the communication apparatus performs predetermined signal processing (transmission-side processing 1 illustrated in FIG. 7) and transmits the information sequence (hereinafter, also referred to as a transmission data sequence) to a coding layer (for example, a PDCP layer). The coding layer executes coding processing on the received transmission data sequence. The coding processing executed here includes a packet coding processing of generating a plurality of coded bit sequences (hereinafter, also referred to as a coded sequence) from one transmission data sequence. The coded sequence undergoes predetermined signal processing (transmission-side processing 2 illustrated in FIG. 7), and then is transmitted to the communication apparatus on the reception side. At this time, a plurality of coded sequences are distributed and transmitted in a plurality of channels.

Next, processing on the reception side will be described with reference to FIG. 8. First, when having acquired an information sequence (hereinafter, also referred to as a received data sequence) from a communication apparatus on a transmission side, a predetermined layer related to signal processing inside the communication apparatus performs predetermined signal processing (reception-side processing 1 illustrated in FIG. 8) and transmits the received data sequence to a decoding layer (for example, the PDCP layer). The decoding layer performs decoding processing corresponding to the transmission-side coding processing (packet coding processing) on the received data sequence. The information sequence generated by the decoding processing undergoes predetermined signal processing (reception-side processing 2 illustrated in FIG. 8) and then transmitted to the upper layer.

### 3-2. Features of Packet Coding

Next, features of packet coding will be described. Note that the decoding processing executed on the reception side is processing corresponding to the coding processing (packet coding processing) on the transmission side, and thus description thereof is omitted.

The packet coding processing includes: a dividing procedure of dividing one transmission data sequence into a plurality of source bit sequences; and a coding procedure of applying coding processing according to a predetermined error correction coding scheme to the plurality of source bit sequences to generate a plurality of coded bit sequences from the plurality of source bit sequences. The packet coding processing does not necessarily include the dividing procedure. Only the coding procedure may be included in the packet coding processing.

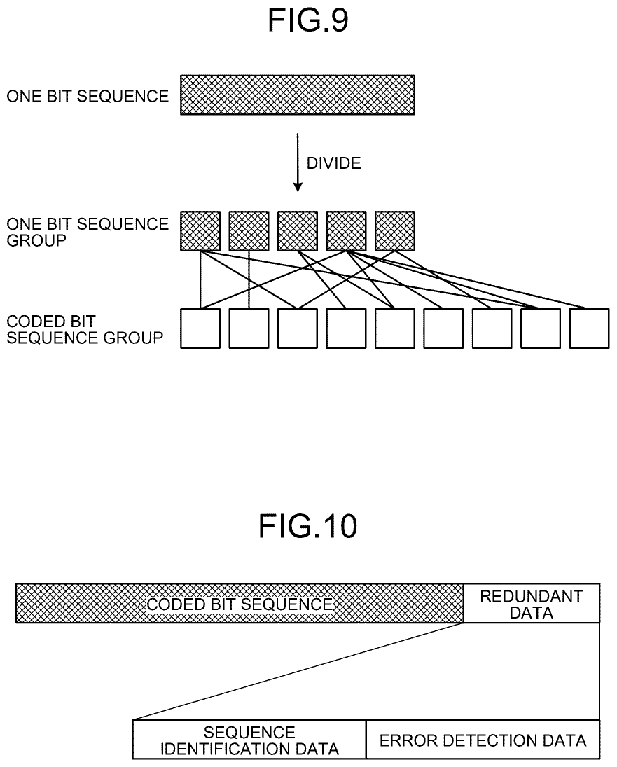

FIG. 9 is a diagram for illustrating packet coding processing. In packet coding, a communication apparatus generates a plurality of source bit sequences from one bit sequence (one transmission data sequence). At this time, the plurality of source bit sequences may have a same length. That is, the communication apparatus may equally divide one bit sequence. Subsequently, the communication apparatus applies predetermined error correction coding processing on a plurality of source bit sequences (one bit sequence group illustrated in FIG. 9) to generate a plurality of coded bit sequences (coded bit sequence group illustrated in FIG. 9) having an error correction capability. At this time, the communication apparatus may generate the coded bit sequence group by performing bit level exclusive OR (XOR) calculation on the source bit sequences. In this case, the bit sequence length of a parity bit sequence is the same as a sequence length of the plurality of source bit sequences (here, corresponding to one bit sequence group) used for input. In order to perform decoding successfully, the communication apparatus on the transmission side needs to transmit, to the reception side, at least coded bit sequences of the quantity (five in the example of FIG. 9) or more of source bit sequences to be coded among a plurality of output coded bit sequences (nine coded bit sequences in the example of FIG. 9). Note that the exemplary illustration in FIG. 9 is merely an example. The packet coding processing is not limited to the example illustrated in FIG. 9.

The error correction coding scheme used in the packet coding processing is desirably a Forward Error Correction (FEC) scheme included in a category such as erasure codes, rateless codes, or fountain codes. The error correction coding scheme used in the packet coding processing may be a scheme in which a plurality of bit sequences is linearly combined or XOR-combined for the coding. Hereinafter, examples of the error correction coding scheme assumed to be used in the packet coding processing will be described in (A1) to (A11) below. Understandably, the error correction coding scheme used in the first coding processing is not limited to the following example.
(A1) Erasure codes
(A2) Rateless codes
(A3) Fountain codes
(A4) Tornado codes
(A5) Luby Transform Codes (LT codes)
(A6) Raptor codes
(A7) RaptorQ codes
(A8) Low Density Parity Check Codes (LDPC codes)
(A9) BCH codes
(A10) Reed Solomon Codes (RS codes)
(A11) exclusive OR Codes (XOR codes)

The communication apparatus assigns redundant data, in units of coded bit sequences, to a plurality of coded bit sequences generated by packet coding. FIG. 10 is a diagram illustrating an example of redundant data assigned to a coded bit sequence. In the example of FIG. 10, the redundant data includes sequence identification data having a symbol identification function and error detection data having an error detection function. The sequence identification data is, for example, an identification number for the purpose of identifying a coded bit sequence. The identification number may be referred to as Identification (ID) or Sequence Number (SN). The identification number is used by the communication apparatus on the reception side to determine which coded sequence on the transmission side the received coded bit sequence corresponds to. The error detection data is used by the communication apparatus on the reception side to detect whether there is an error in the coded bit sequence. When generating the error detection data, the communication apparatus on the transmission side may further perform coding processing on the coded sequence. An example of further coding processing is Cyclic Redundancy Check (CRC).

A specific example of the packet coding processing (coding procedure/decoding procedure) will be described below.

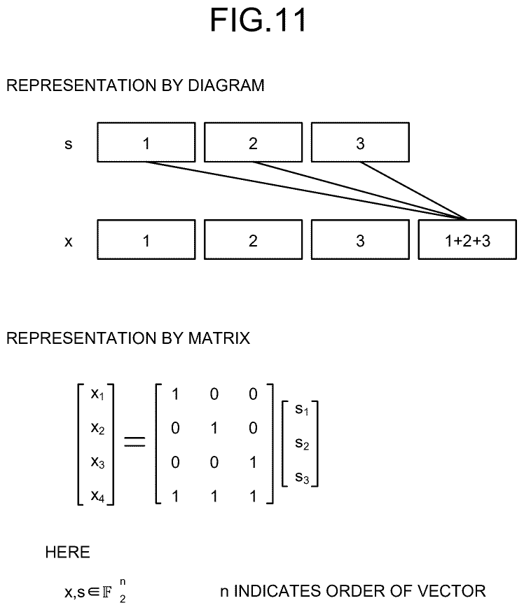

FIG. 11 is a diagram illustrating an example of a coding procedure of packet coding processing. As described above, the coding procedure of the packet coding processing may be regarded as the packet coding processing. Not all the packet coding illustrated in (A1) to (A11) follows the same procedure as that in FIG. 11. FIG. 11 illustrates a process of generating one new parity bit sequence by coding using one of three bit sequences as an input. In the example of FIG. 11, the parity is generated by using bit-level addition of bit sequences of equal lengths. In this case, the coding technique can be represented by a matrix operation. In the matrix representation of FIG. 11, the matrix on the left side of the right side is a coding matrix. In the example of FIG. 11, a plurality of bit sequences (components of the first to third rows of the matrix) same as the input and a parity bit sequence (components of the fourth row of the matrix) are generated as the coded bit sequence group.

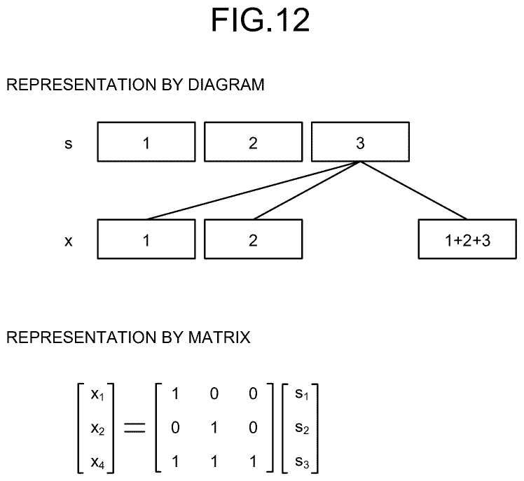

FIG. 12 is a diagram illustrating an example of a coding procedure of a plurality of received coded bit sequences. Note that the decoding procedure illustrated in FIG. 12 does not correspond to all the packet coding schemes illustrated in (A1) to (A11). FIG. 12 illustrates a state of performing a correction using a parity bit sequence in a case where one coded bit sequence at an arbitrary position is lost. Whether the lost sequence can be corrected is equivalent to whether the equation can be solved when the matrix constructed with the row components of the coding matrix corresponding to the correctly delivered coded bit sequence is regarded as a linear equation.

### 3-3. Exemplary Procedure of Packet Coding Processing

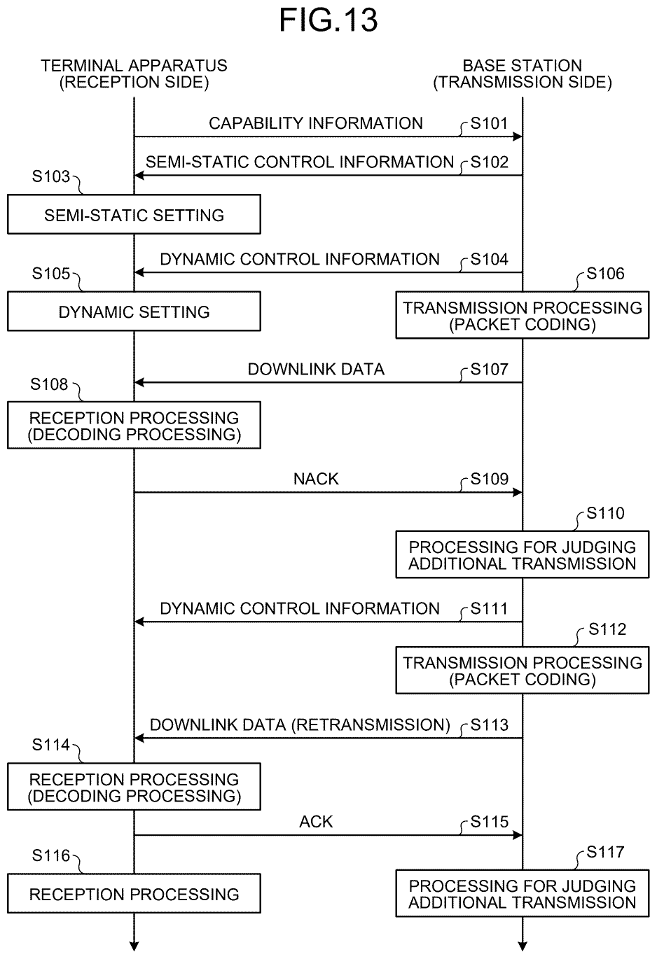

Next, an exemplary procedure of packet coding processing will be described. FIG. 13 is a sequence diagram illustrating an exemplary procedure of packet coding processing. The exemplary procedure illustrated in FIG. 13 is merely an example, and the procedure of the packet coding processing is not limited to this exemplary procedure. Furthermore, although FIG. 13 illustrates downlink communication from the base station 30 to the terminal apparatus 40, the technology disclosed in the present embodiment is also applicable to other communication (for example, uplink communication from the terminal apparatus 40 to the base station 30). Hereinafter, an exemplary procedure of packet coding processing of the present embodiment will be described with reference to the sequence diagram of FIG. 13.

First, the terminal apparatus 40 notifies the base station 30 of the connected cell of information related to its own terminal capability (step S101). The information also includes capability information for packet coding. The terminal apparatus 40 may notify the information related to the terminal capability during a procedure of initial connection (initial access) or after the initial connection. The notification may be performed by using a physical channel, for example, at least one of a Random Access Channel (PRACH), a Physical Uplink Control Channel (PUCCH), and a Physical Uplink Shared Channel (PUSCH).

The base station 30 notifies the terminal apparatus 40 connected to the cell managed by the base station itself of semi-static control information including information related to packet coding (coding/decoding) (step S102). The semi-static control information may be cell-specific control information.

The base station 30 may notify the semi-static control information during the procedure of the initial connection or after the initial connection (initial access). Furthermore, the base station 30 may notify this control information as part of an RRC procedure such as RRC signaling, RRC configuration, or RRC reconfiguration. Furthermore, the base station 30 may periodically notify the terminal apparatus 40 of the control information. The notification of the control information may be performed by using a physical channel, that is, at least one of a Physical Broadcast Channel (PBCH) ), a Physical Downlink Control Channel, Enhanced Physical Downlink Control Channel (EPDCCH), and a Physical Downlink Shared Channel.

When having received the semi-static control information, the terminal apparatus 40 performs setting related to coding based on the information related to packet coding included in the received control information (step S103).

Thereafter, when downlink communication occurs from the base station 30 to the terminal apparatus 40, the base station 30 transmits dynamic control information to the terminal apparatus 40 (step S104). Examples of a case where downlink communication occurs include a case where the terminal apparatus 40 requests data download (pull) and a case where push data occurs to the terminal apparatus 40. The dynamic control information may be terminal-specific (UE-specific) control information or terminal-group-specific (UE-group-specific) control information. Here, the terminal group is, for example, a group of one or more terminal apparatuses 40 which are transmission destination targets in a case where the downlink communication is multicast or broadcast communication.

Note that the dynamic control information can include various types of information such as information related to a radio resource used to perform downlink communication. For example, the dynamic control information can include, for example, information related to various resources for allocating downlink communication to the target terminal apparatus 40 (terminal apparatus 40 group). More specifically, the dynamic control information can include, for example, the following information (1) to (9).
(1) Frequency resource (for example, a resource block, a subcarrier, a subcarrier group or the like)
(2) Time resource (for example, a subframe, a slot, a mini-slot, a symbol, or the like)
(3) Spatial resource (for example, an antenna, an antenna port, a spatial layer, a spatial stream, or the like)
(4) Non-orthogonal resources (for example, resources related to power, an interleave pattern, a scrambling pattern, a diffusion pattern, and the like) for a predetermined communication (for example, Non-orthogonal Multiple Access (NOMA), Multiuser Superposition Transmission (MUST), Interleave Division Multiple Access (IDMA), Code Division Multiple Access (CDMA) and the like)
(5) Modulation Order
(6) Coding method used in packet coding (for example, the error correction coding scheme)
(7) Information related to coding rate of packet coding
(8) Information related to redundant data assigned to coded sequence (for example, information related to an error detection method and an identification number of a coded sequence)
(9) ARQ/HARQ setting (for example, New Data Indicator (NDI), Redundancy Version (RV), and the like)

The terminal apparatus 40 that has received the dynamic control information performs setting for preparing for appropriate reception of downlink communication according to the control information (step S105).

Next, the base station 30 performs coding of the downlink communication data to the terminal apparatus by using packet coding processing so that the information sequence subjected to the transmission processing in the upper layer matches the control information notified to the terminal apparatus 40, and performs the transmission processing (including modulation, physical layer coding, and the like) including the physical layer processing (step S106). The base station 30 transmits the coded and modulated data to the terminal apparatus 40 as a radio signal (step S107).

Having receiving the data from the base station 30, the terminal apparatus 40 performs various types of processing (reception processing, demodulation processing, and decoding processing) including coding processing corresponding to the packet coding processing according to the setting designated in the control information (step S108). For example, the terminal apparatus 40 discerns whether a restored coded sequence includes an error. Subsequently, the terminal apparatus 40 attempts decoding using only the coded sequence including no error. Thereafter, the terminal apparatus 40 returns ACK or NACK to the base station 30 depending on whether the data decoding has been successful or has resulted in failure. In addition, the terminal apparatus 40 desirably changes the setting (for example, setting ARQ/HARQ processing) of the processing related to the additional transmission depending on whether the data decoding has been successful or has resulted in failure. In a case where the decoding has resulted in failure, the terminal apparatus 40 desirably stores decoding result or data in the middle of decoding (coded sequence) in the memory in order to perform retransmission and combining including the subsequently received coded sequence. When the decoding has been successful, the terminal apparatus 40 performs processing for data transfer to the upper layer. In the example of FIG. 13, the terminal apparatus 40 has failed in decoding and returns NACK to the base station 30 (step S109).

The base station 30 executes processing to be performed next according to the response (ACK/NACK) received from the terminal apparatus 40. For example, in a case where a notification of NACK has been received, preparation for transmission of an additional information sequence is performed (step S110). Examples of preparation for this transmission include generation of a new coded sequence by packet coding, transmission processing necessary for transmission, and selection of radio resources. Reception of ACK from the terminal apparatus 40 indicates that transmission and reception of the target data have been performed without any problem, and thus, the process shifts to communication of next new data.

The base station 30 proceeds to perform downlink communication as retransmission or transmission of new data according to the processing for additional transmission corresponding to the above response (ACK/NACK). For this purpose, the base station 30 notifies the target terminal apparatus 40 of dynamic control information again, and executes the downlink communication according to the setting.

In the example of FIG. 13, since NACK has been received from the terminal apparatus 40 (step S109), the base station 30 executes processing for judging additional transmission (step S110) and notifies the terminal apparatus 40 of dynamic control information again (step S111). The terminal apparatus 40 that has received the dynamic control information performs setting for preparing for appropriate reception of downlink communication according to the control information. The base station 30 performs various types of processing including packet coding processing on the downlink communication data addressed to the terminal apparatus 40 so as to match the control information notified to the terminal apparatus 40 (step S112). Subsequently, the base station 30 retransmits the coded data to the terminal apparatus 40 (step S113).

The terminal apparatus 40 combines the data based on the retransmission signal, and executes various types of processing (reception processing, demodulation processing, and decoding processing) including the coding processing corresponding to the packet coding processing on the combined data according to the setting designated in the control information (step S114). In the example of FIG. 13, the terminal apparatus 40 has been successfully decoded at the point, returns ACK to the base station 30 (step S115), and executes the remaining reception processing (step S116).

Having received ACK, the base station 30 performs processing for judging additional transmission (step S117) and shifts to communication of next new data.

### 4. First Embodiment

The packet coding as a premise of the transmission/reception processing of the present embodiment has been described above. Next, operations of the communication system 1 of the first embodiment will be described below.

### 4-1. Outline of First Embodiment

First, an outline of the first embodiment will be described.

### Background

The 3GPP NR standards (mainly Rel-15 and later versions) support a function referred to as Multi-TRP (also referred to as MTRP, M-TRP, or mTRP). Multi-TRP is a function of transmitting a single or a plurality of transport blocks by cooperatively using a plurality of transmission and reception points (TRPs) at a physical layer level. An outline of the Multi-TRP is described in Literatures such as Non-Patent Literature 1 (3GPP TSG-RAN RP-202803) and Non-Patent Literature 2 (3GPP TSG-RAN WG2R2-1914020), for example.

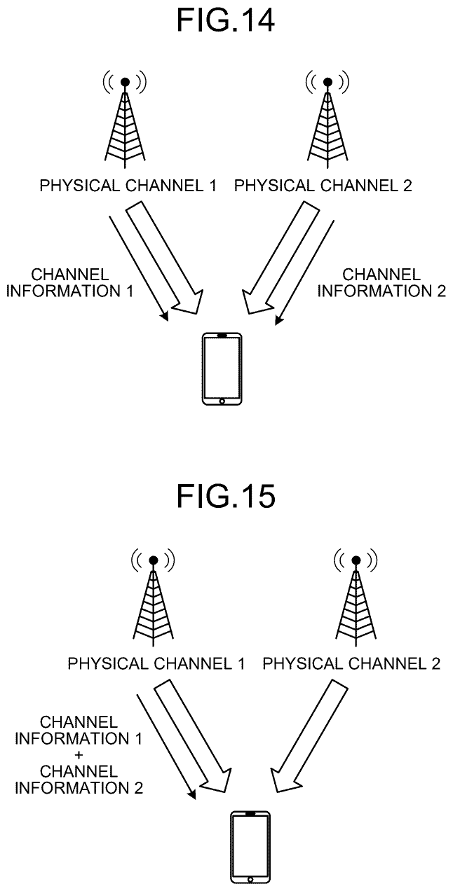

Multi-TRPs are roughly classified into two modes. FIGS. 14 and 15 are diagrams each illustrating a mode of a multi-TRP.

FIG. 14 is a diagram illustrating a first mode of the multi-TRP. In the first mode, channel information of each TRP is independently exchanged with the UE. The first mode assumes use of a fronthaul between TRPs during non-ideal communication.

FIG. 15 is a diagram illustrating a second mode of the multi-TRP. In the second mode, the channel information of the UE and each TRP is collectively exchanged via a single TRP. This assumes the use of the fronthaul between TRPs during ideal communication. The second mode uses less number of times of exchange of channel information compared to the first mode.

These modes assume a use method of improving communication reliability by transmitting the same data on each TRP. In each mode, these controls are performed by a single Media Access Control Entity (MAC entity).

In the case of a multi-TRP, a transport block size (TRS) handled by each TRP is determined by channel information or a resource amount. Here, the channel information includes a value of a Modulation and Coding Scheme (MCS) and/or a Channel Quality Indicator (CQI) determined by the information. In addition, the information on the resource amount includes at least one piece of information such as the number of available resource blocks and the number of layers.

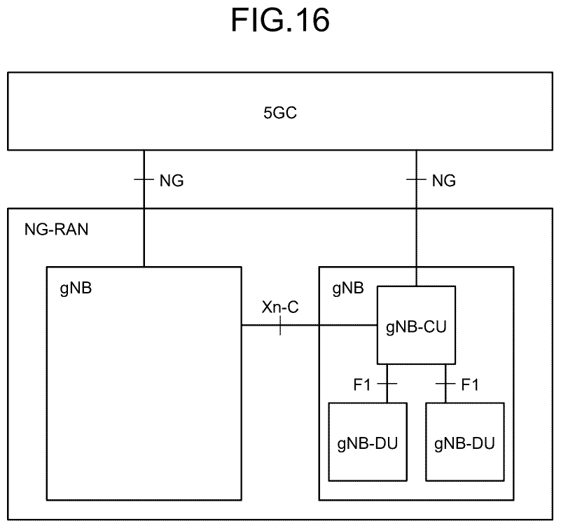

Non-Patent Literature 3 (3GPP TS 38.401V 16.8.0 ) describes an NG RAN architecture defined by 3GPP. FIG. 16 is a diagram illustrating an example of an NG RAN architecture.

In the current standard, functions of a base station (in the example of FIG. 16, qNB) are separated into two: a Central Unit (CU) and a Distributed Unit (DU). A boundary line (also referred to as a split point, or a division point) between the CU and the DU is set between a Packet Data Convergence Protocol (PDCP) layer and a Radio Link Control (RLC) layer in a 3GPP protocol stack.

Here, the DU may include some or all of functions known by names such as Radio Remote Head (RRH), Remote Radio Unit (RRU), and Radio Unit (RU) as named in 3GPP LTE. One gNB is assumed to include one CU and one or a plurality of DUs. In addition, one DU can establish a connection between only one CU.

For communication flexibility, one DU may be connected to a plurality of CUS in a proper implementation. In order to establish communication between the CU and the DU, 3GPP defines “F1” as an interface between these units. This interface is a logical interface. For example, the IP packet passes through a network such as Ethernet (registered trademark) (IEEE 802.3) to establish communication between the CU and the DU.

### Problems

In a communication system using multi-TRPs, there may be problems in efficiency and flexibility in achieving communication reliability. Here, the problem of efficiency and flexibility includes the following problems (1) to (3), for example.

(1) In a case where channel information between each TRP-UE is different, that is, a transport block size (TBS) is different for each TRP, the same amount of information cannot be transmitted at each TRP.
(2) In a case where the transport blocks (TB) of the same size cannot be handled by each TRP, the reception side MAC layer cannot perform synchronization in units of subMAC Protocol Data Unit (PDU) or MAC Service Data Unit (SDU).
(3) The method of simply duplicating the same data (for example, the subMAC PDU or MAC SDU) and judging success of transmission for each transport block is not preferable from the viewpoint of coding efficiency.

### Solution

In view of these, the first embodiment is provided to solve the above problem by introducing Forward Error Correction (FEC) at the packet level into labor before the upper layer (particularly before processing of generating the TB from the upper layer packet). An outline of the solution of the embodiment will be described below.

The communication system 1 of the first embodiment includes: a transmission apparatus (for example, the base station 30) capable of performing communication by multi-TRP; and a reception apparatus (for example, the terminal apparatus 40) capable of performing communication by multi-TRP.

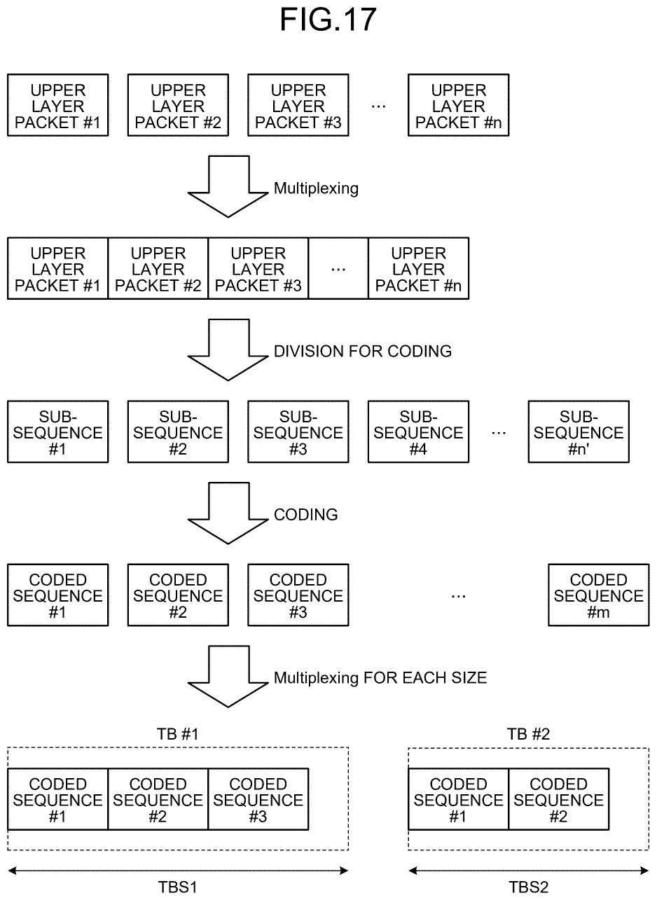

FIG. 17 is a diagram illustrating an outline of transmission processing according to a first embodiment. The transmission apparatus multiplexes a plurality of upper layer packets to generate one transmission data sequence. Subsequently, the transmission apparatus generates a plurality of coded sequences from one transmission data sequence by using packet coding. At this time, the packet coding processing includes: a procedure of dividing one transmission data sequence into a plurality of subsequences; and a procedure of applying coding processing according to a predetermined error correction coding scheme to the plurality of subsequences to generate a plurality of coded sequences from the plurality of subsequences. The transmission apparatus distributes the plurality of coded sequences for each TRP based on the information of the transport block size of each of the plurality of TRPs. Subsequently, the transmission apparatus generates a transport block of each of the plurality of TRPs based on the distributed coded sequence.

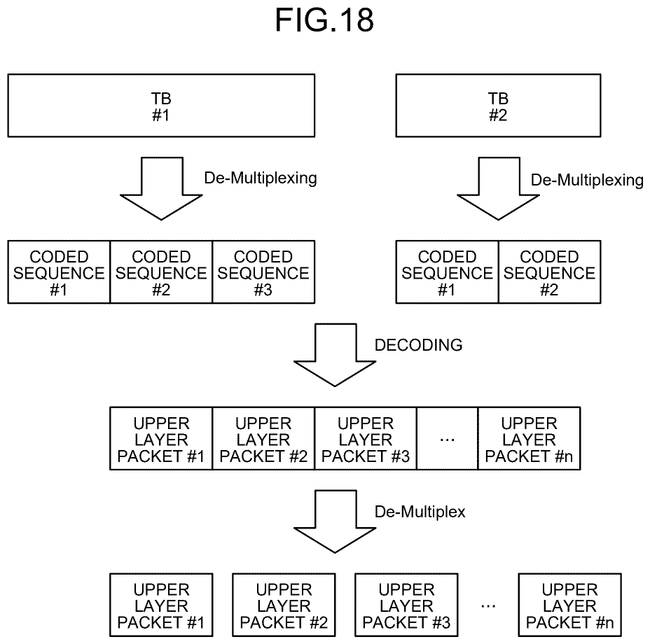

FIG. 18 is a diagram illustrating an outline of reception processing according to the first embodiment. The reception apparatus receives a plurality of transport blocks from the transmission apparatus. Subsequently, the reception apparatus extracts a plurality of coded sequences from each of the plurality of transport blocks. The reception apparatus decodes the plurality of extracted coded sequences using a decoding method corresponding to packet coding. Subsequently, the reception apparatus separates the decoded data into a plurality of upper layer packets.

### Effects

The PHY belonging to each TRP receives a coded symbol group generated from the same upper layer packet group satisfying a request of each transport block size (TBS) as a transport block (TB) from the upper layer. Therefore, data transmitted for each TRP can be synchronized when checked in units of upper layer packets. That is, by performing coding in the upper layer, the communication system 1 can change a sequence of a certain size to any size while saving the information amount, making it possible to support any TBS. As a result, the communication system 1 can improve efficiency and flexibility in achieving communication reliability.

### 4-2. Operation of Communication System 1 of First Embodiment

The overview of the first embodiment has been described above. Hereinafter, the operation of the communication system 1 of the first embodiment will be described.

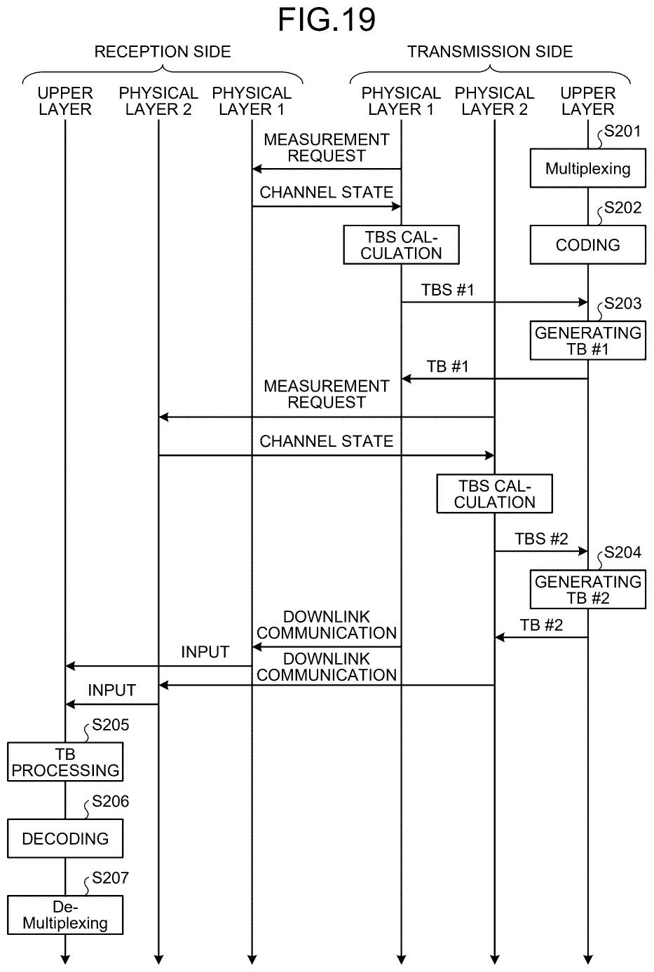

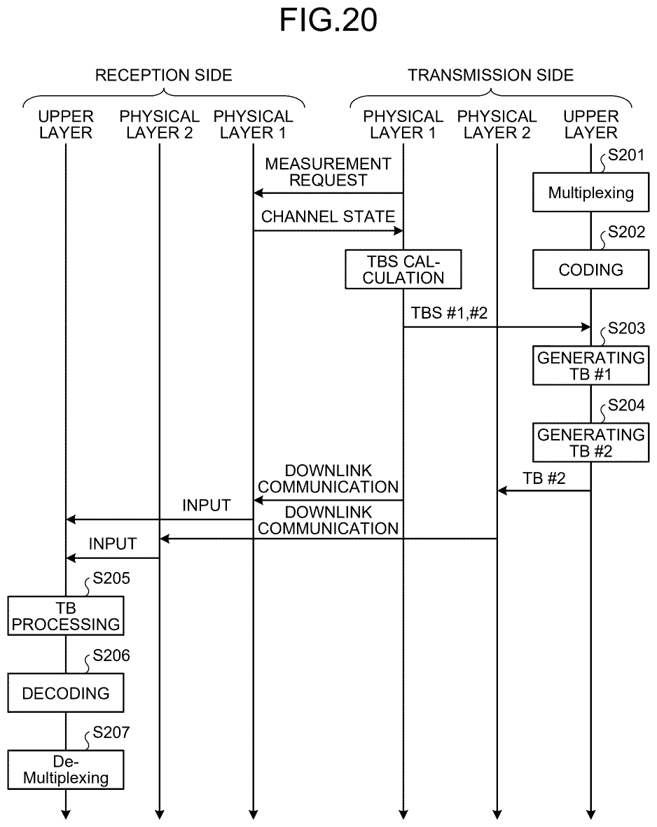

FIGS. 19 and 20 are sequence diagrams illustrating transmission/reception processing according to the first embodiment. In the examples of FIGS. 19 and 20, the communication system 1 includes two TRPs (physical layers). In the example of FIG. 19, each physical layer separately performs calculation of transport block size (TBS) and processing necessary for the calculation. In the example of FIG. 20, one physical layer representatively acquires channel information between transmission and reception point-RX, and calculates each TBS. In the examples of FIGS. 19 and 20, the TX physical layer 1 and the RX physical layer 1 are in a correspondence relationship, while the TX physical layer 2 and the RX physical layer 2 are in a correspondence relationship. As long as each transmission point and TB can be handled independently, they need not be the physical layer. For example, these may be low-PHY, RHH, or RU.

The transmission/reception processing according to the first embodiment will be described below with reference to FIGS. 19 and 20. In FIGS. 19 and 20, the corresponding processes are denoted by the same step numbers. In the following description, a communication apparatus on the transmission side may be referred to as a transmission apparatus, and a communication apparatus on the reception side will be referred to as a reception apparatus.

First, the transmission apparatus executes multiplexing processing of upper layer packets (step S201). For example, the transmission apparatus multiplexes a plurality of upper layer packets to generate one transmission data sequence. Here, the upper layer packet refers to a packet before undergoing physical layer transport. For example, the upper layer packet may be any one of the following (1) to (4).
(1) subMAC PDU, MAC SDU
(2) RLC PDU, RLC SDU
(3) PDCP PDU, PDCP SDU
(4) Bit sequence generated above physical layer

Subsequently, the transmission apparatus determines the size of the bit sequence (one transmission data sequence) generated after the multiplexing processing. Note that this processing may be omitted. In addition, the transmission apparatus may use information related to one or a plurality of communications in order to determine the size.

At this time, the information related to communication may be information related to a channel state (for example, DCI).

Furthermore, the information related to communication may be information to be used for radio bearer (Radio Bearer), establishment of a logical layer, and Reconfiguration. For example, the information related to communication may be information included in RRC Signal, MAC CE, RLC Control PDU, or PDCP Control PDU.

Furthermore, the information related to communication may be control information for the logical layer. For example, the information related to communication may be information included in RRC Signal, MAC CE, RLC Control PDU, or PDCP Control PDU.

Furthermore, in order to determine the size, the transmission apparatus may use information regarding a TBS of each of the plurality of transmission and reception points to (for example, TBS notified from each physical layer). For example, the transmission apparatus may determine the largest size among the plurality of transport block sizes as the size of the bit sequence (one transmission data sequence). In a case where communication is performed using two TRPs, when each TBS (TBS1/TBS2) is notified from the PHY layer (PHY1/PHY2) to which each TRP belongs, the transmission apparatus may compare the size of TBS1 and TBS2 and determine the larger one as the size of the bit sequence (one transmission data sequence). Understandably, the algorithm used by the transmission apparatus to determine the size is not limited to the above.

After determining the size, the transmission apparatus multiplexes a plurality of packets to obtain the determined size. At this time, the transmission apparatus may perform zero padding after multiplexing so as to obtain the determined size.

Subsequently, the transmission apparatus performs coding processing on the multiplexed bit sequence (one transmission data sequence) (step S202). Specifically, the transmission apparatus performs packet coding processing on one transmission data sequence. The packet coding processing includes: a dividing procedure of dividing one transmission data sequence into a plurality of subsequences; and a generating procedure of applying coding processing according to a predetermined error correction coding scheme to the plurality of subsequences to generate a plurality of coded sequences from the plurality of subsequences.

### Dividing Procedure

The transmission apparatus determines the number of divisions of one transmission data sequence according to a predetermined condition, and divides one transmission data sequence into a plurality of subsequences so as to obtain the determined number of divisions.

At this time, the transmission apparatus may determine the number of divisions of one transmission data sequence based on reliability information required in transmitting the transmission data sequence. For example, the transmission apparatus may determine the number of divisions of one transmission data sequence based on a value of a 5G QoS Identifier (5QI) set in a Data Radio Bearer (DRB).

Furthermore, the transmission apparatus may determine the number of divisions of one transmission data sequence based on any value or a notification from another communication apparatus. For example, the transmission apparatus may determine the number of divisions of one transmission data sequence based on the number of available TRPs. In addition, the transmission apparatus may determine the number of divisions of one transmission data sequence based on the notification in the configuration/re-configuration, establishment, and re-establishment of the logical layer.

Furthermore, the transmission apparatus may determine the number of divisions of one transmission data sequence based on the information of the transport block size (TBS). For example, the number of divisions of one transmission data sequence may be determined based on the size of the transport block determined by the information notified from the terminal apparatus 40 represented by PUCCH.

For example, the transmission apparatus may determine the size of one subsequence from common divisors of two TBSs among the TBSs notified from each TRP, and may determine the number of divisions based on the determined size. When this method is used to multiplex one or a plurality of coded sequences to generate a transport block, each TRP can receive, from the upper layer, a transport block having the same size as the notified TBS. Therefore, this method is effective from the viewpoint of improving efficiency in resource specifications.

For example, the transmission apparatus may determine the size of one subsequence from a divisor of any one TBS among the TBS notified from each TRP, and may then determine the number of divisions based on the determined size. This method is effective in that the number of divisions can be determined by a method with lower complexity than the above method.

Furthermore, the transmission apparatus may determine the number of divisions of one transmission data sequence based on the state of the physical layer. For example, the transmission apparatus may determine the number of divisions of one transmission data sequence based on the state of the channel. Furthermore, the transmission apparatus may determine the number of divisions of one transmission data sequence based on a Modulation and Coding Scheme (MCS). In addition, the transmission apparatus may determine the number of divisions of one transmission data sequence based on a QoS Class Identifier (QCI). In addition, the transmission apparatus may determine the number of divisions of one transmission data sequence based on resource allocation.

The merits and demerits in determining the number of divisions (or increasing/decreasing the size of the subsequence) are as follows.

Basically, it is assumed that a header is assigned to each coded sequence for the purpose of performing Point to Point sharing of information to be used for decoding. The header is a redundant component that increases, in total amount, in proportion to the number of coded sequences used for transmission. On the other hand, as described above, when coding is performed using n subsequences, the minimum number of coded sequences necessary for decoding is n. Therefore, decoding cannot be successful unless the transmission side transmits at least n sequences by some method. That is, the larger the value n, the greater the redundant component due to the header. However, in a case where the size of the coded sequence is increased, the coded sequence would not fit in the TBS transmitted from the physical layer corresponding to each TRP, or would fit but with a large amount of blank space. For example, when TBS is 20 and the size of the coded sequence is 13, it is assumed that the transport block has seven blank spaces. In this regard, decreasing the size of the coded sequence is assumed to also decrease the blank space of the transport block. In this respect, it is effective to reduce the size of the coded sequence.

### Generating Procedure

The transmission apparatus performs coding processing using the subsequence group. Subsequently, the transmission apparatus assigns a header to each coded sequence. The header is not necessarily to be assigned. In a case where the header is assigned, the header includes at least one piece of information described in the following (1) to (3).
(1) Information for identifying a coded sequence.
(2) A function capable of detecting an error in a coded sequence or a function equivalent thereto.
(3) Information used in de-multiplexing (for example, a unit coded sequence length).

The transmission apparatus distributes a plurality of coded sequences for each TRP based on information of a transport block size of each of a plurality of transmission and reception points. Subsequently, the transmission apparatus generates a transport block of each of the plurality of TRPs based on the distributed coded sequence (steps S203 and S204).

For example, the transmission apparatus multiplexes the coded sequence such that the size is closer to the requested TBS or below. At this time, the requested TBS is a TBS requested by the PHY layer belonging to one UE-TRP connection. A total size of the coded sequence transmitted to the plurality of PHY layers is equal to or larger than a size of a sequence (one transmission data sequence) after multiplexing of the plurality of upper layer packets. The multiplexed coded sequences may be duplicated when viewed for each physical layer to be transmitted.

Furthermore, the transmission apparatus may assign a header to the multiplexed sequence (that is, the transport block). The header is not necessarily to be assigned. In a case where the header is assigned, the header includes at least the information illustrated in (1) to (2).
(1) Information used in de-multiplexing (for example, a unit coded sequence length).
(2) Control information (for example, HARQ-ID) required for the transport block.

The physical layer of the transmission apparatus transmits the transport block to the reception apparatus. The physical layer of the reception apparatus receives the transport block from the transmission apparatus. The reception apparatus receives the transport block from a physical layer.

The reception apparatus de-multiplexes the transport block received from the physical layer (step S205). This processing may be sequentially performed on the transport block delivered from the physical layer. The reception apparatus may hold information necessary for demultiplexing as a value that does not vary by any information or operation. Furthermore, the reception apparatus may receive information necessary for demultiplexing from the transmission apparatus. This information may be transmitted in a form included in the control information for each TRP. Furthermore, this information may be transmitted in a form included in a header assigned to the transport block.

The reception apparatus may perform demultiplexing of the transport block according to the notification in the configuration/re-configuration, establishment, or re-establishment of the logical layer.

Next, the reception apparatus performs decoding processing on the plurality of coded sequences acquired by demultiplexing (step S206). For example, the reception apparatus decodes the plurality of coded sequences by using the decoding method corresponding to the packet coding used in step S202. At this time, the reception apparatus may judge the start timing of the decoding processing.

For example, the reception apparatus may start decoding a plurality of coded sequences at a timing of receiving the coded sequences of a quantity or a length satisfying a predetermined criterion. For example, the reception apparatus judges whether the quantity (or length) of correctly received coded sequences satisfies a predetermined criterion. At this time, the reception apparatus may judge whether coded sequences having the same number of divisions have been received. Furthermore, the reception apparatus may judge whether the coded sequences of quantity judged to have high expected values for achieving target reliability have been received. When the predetermined criterion is satisfied, the reception apparatus starts decoding the plurality of coded sequences.

Furthermore, the reception apparatus may start decoding the plurality of coded sequences at a timing when a timer prompting the start of decoding satisfies a predetermined criterion. The timer may be set by the transmission apparatus or may be set by the reception apparatus.

Next, the reception apparatus de-multiplexes the decoded sequence (step S207). The reception apparatus may hold information necessary for demultiplexing as a value that does not vary by any information or operation. Furthermore, the reception apparatus may receive information necessary for demultiplexing from the transmission apparatus. This information may be transmitted in a form included in the control information for each TRP. Furthermore, this information may be transmitted in a form included in a header assigned to the transport block. The reception apparatus may perform demultiplexing of the transport block according to the notification in the configuration/re-configuration, establishment, or re-establishment of the logical layer.

According to the first embodiment, the communication system 1 can handle a case where the transport block size is different for each transmission and reception point. As a result, the communication system 1 can improve efficiency and flexibility in achieving communication reliability.

### 5. Second Embodiment

Next, an operation of the communication system 1 of the second embodiment will be described.

### 5-1. Outline of Second Embodiment

First, an outline of the first embodiment will be described.

### Background

Non-Patent Literature 3 (3GPP TS 38.401V 16.8.0 ) describes an NG RAN architecture defined by 3GPP. For example, Non-Patent Literature 3 discloses an NG RAN architecture as illustrated in FIG. 16, for example.

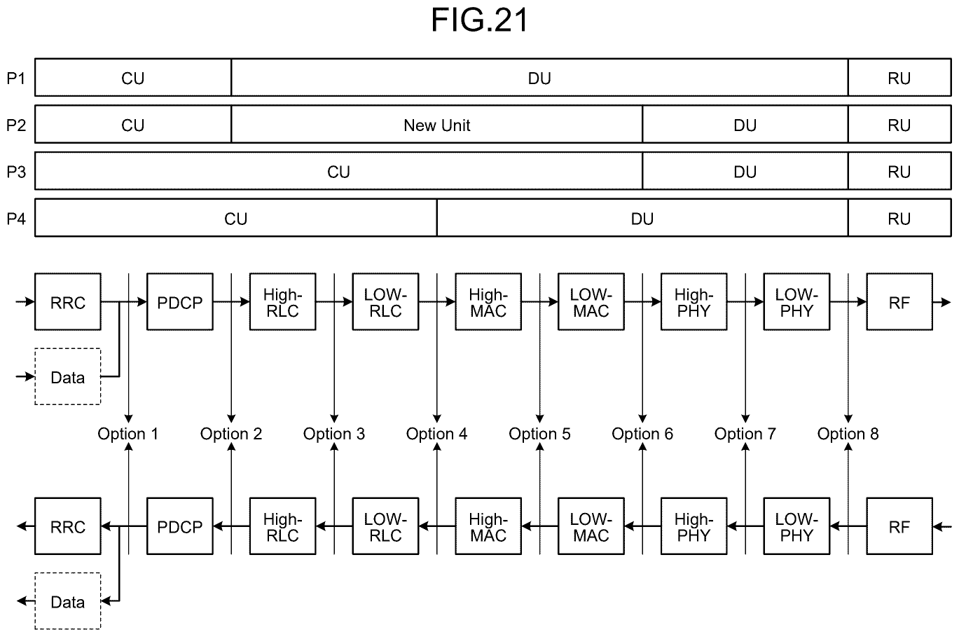

In the current standard, functions of a base station (in the example of FIG. 16, gNB) are separated into two: a Central Unit (CU) and a Distributed Unit (DU). FIG. 21 is a diagram for illustrating a boundary line between the CU and the DU. Currently, a boundary line (also referred to as a split point or a division point) between the CU and the DU is set between the PDCP layer and the RLC layer (Option 2) in the 3GPP protocol stack, as illustrated in Pl in FIG. 21.

Here, the DU may include some or all of functions known by names such as Radio Remote Head (RRH), Remote Radio Unit (RRU), and Radio Unit (RU) as named in 3GPP LTE. One gNB is assumed to include one CU and one or a plurality of DUs. In addition, one DU can establish a connection between only one CU.

For communication flexibility, one DU may be connected to a plurality of CUS in a proper implementation. In order to establish communication between the CU and the DU, 3GPP defines “F1” as an interface between these units. This interface is a logical interface. For example, the IP packet passes through the Ethernet (IEEE 802.3) to establish communication between the CU and the DU.

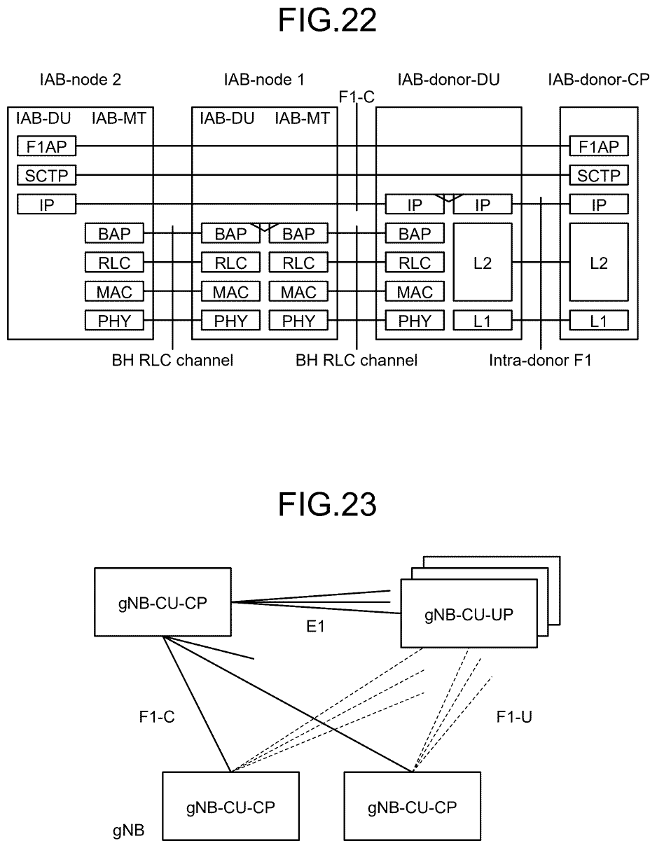

Since a general public network is used as a communication path, F1 is a non-ideal wired interface that is difficult to achieve synchronization between communication routes. As some exceptions, there is a case where F1 is provided wirelessly. Integral And Backhaul (IAB) corresponds to this case. FIG. 22 is a diagram illustrating an example of an IAB architecture (C-plane). In IAB, F1 is provided as a wireless interface between DU on an IAB donor or an IAB node and a Mobile Terminal (MT) on an IAB node.

In addition, the CU and the DU may be implemented on divided planes, namely, a control plane (CP) and a user plane (UP). FIG. 23 is a diagram illustrating an example of an architecture of a gNB in a state in which a CP and an UP are separated. In the 3GPP standard, a gNB includes one CU-CP, a plurality of CU-UPs, and a DU.

### Communication Architecture Assumed by Present Embodiment

The division point, that is, at which point the CU-DU is to be split had been discussed at the timing of Rel-14. As a result of the discussion, the split at the current split point considered to have the best balance between the throughput requirement and the delay requirement in the current implementation was adopted (P1 illustrated in FIG. 21). However, it is estimated, in the future, to adopt splitting at other split points (for example, P2 to P4 illustrated in FIG. 21). That is, it is estimated, in the future, to have physically, logically, or virtually divided functions for communication, and have a network configuration with a communication architecture having a topology that allows redundancy (diversity) in a communication route.

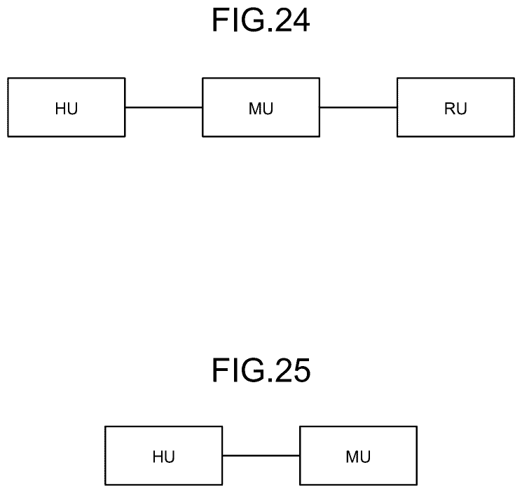

Accordingly, in the present embodiment, for example, when focusing on unit definition by separation of base station functions, network configuration is assumed to take the following modes. FIG. 24 is a diagram illustrating an example of a basic mode of a network configuration. In FIG. 24, the HU, the MU, and the RU are defined as follows:

### Higher Unit (HU)

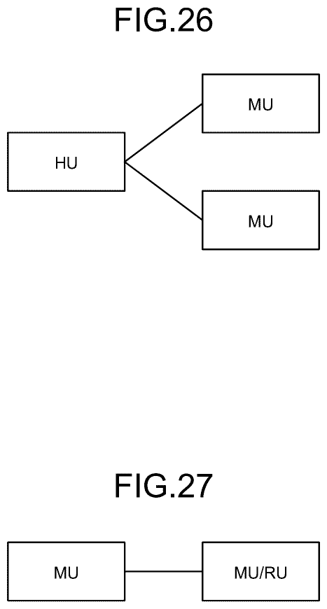

The HU is a unit of the highest layer when function split of a network configuration is performed. The HU includes, for example, a core network function or a control entity function. For example, one HU is defined for each slice or bearer. FIGS. 25 and 26 are diagrams illustrating examples of the architecture that can be adopted by the HU. The HU adopts one of the modes illustrated in FIGS. 25 and 26. The HU may be virtually constructed on a cloud server, or may be defined to be virtually separated on the same server or device as other units. In a case where the HU is defined as a function ranging from the core network and onward (the gNB side of the NG interface) to the PDCP layer, the HU is the same as the CU in the current standard of 3GPP. In addition, the HU may be separately configured in the UP and the CP. In this case, on the CP side, one HU (HU-CP) may be defined. In addition, on the UP side, HU (HU-UP) may be defined as one HU or a plurality of HUs.

### MU (Middle Unit)

The MU is a unit existing in the middle of the Higher Unit (HU) and the Radio Unit (RU) when function split of a network configuration is performed. One MU is defined in a form of being dependent on one HU or one or a plurality of MUs. Furthermore, the MU may be defined in plurality for one HU or one or a plurality of MUs. FIGS. 27, 28, and 29 are diagrams illustrating exemplary architectures that can be adopted by the MU and the RU. The MU adopts one of the modes illustrated in FIGS. 27, 28, and 29. The MU may be virtually constructed on a cloud server, or may be defined to be virtually separated on the same server or device as other units. One MU may be subjected to function split for the purpose of further splitting of a function. In that case, each MU may be distinguished by a name such as Upper-MU and Lower-MU in the order of a protocol stack in 3GPP, for example. For example, when the MU is a unit including all analog parts including an RLC layer function to an RF function, the MU corresponds to the DU in a current standard of 3GPP.

### Radio Unit (RU)

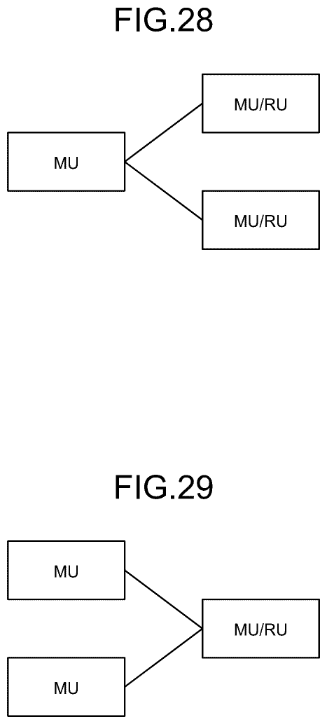

The RU is a unit of the lowest layer when function split of a network configuration is performed. The RUs may include, for example, analog functions, RF devices, and antennas. One RU is defined in a form of being dependent on one or a plurality of MUs. Furthermore, the RU may be defined in plurality for one or more MUs. The RU adopts one of the modes illustrated in FIG. 27, FIG. 28, and FIG. 29. The transmission signals transmitted by one RU may be separated in a physical or logical separation technique. For example, a transmission signal transmitted by one RU may be separated on a time axis, a frequency axis, or a space by using a property such as orthogonality. In order to implement the separation, the RU may include a plurality of transmission points having a physical distance or a transmission apparatus including a plurality of antennas. As an example, a Remote Radio Head (RRH), Radio Equipment (RE), and a Remote Radio Unit (RRU) can also be defined as a mode of an RU.

### Inter-Unit Interface

Note that the connection state of the interface (HU-MU, MU-MU, MU-RU) between each unit is allowed as follows. In the case of using a wired connection, Ideal (state capable of achieving synchronization and controlling the state of the communication path) and Non-Ideal (for example, case of using a communication network such as Ethernet) are allowed. In the case of using a wireless connection, regarding a state of a certain interface at CU-RU defined by one slice or bearer, a certain connection state is allowed independently. Note that the HU-MU connection corresponds to the backhaul or midhaul described above. The MU-MU connection corresponds to the midhaul described above. The MU-RU connection corresponds to the fronthaul described above.

### Architecture

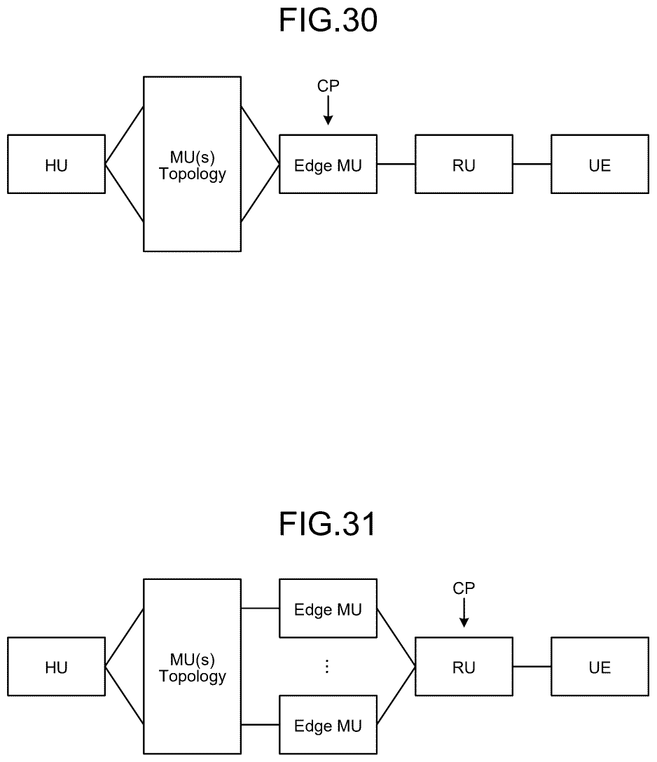

FIGS. 30 to 33 are diagrams illustrating a communication architecture assumed in the present embodiment. Here is an assumable case where the network configuration includes one bearer or slice and there is route redundancy between the HU and the UE. In the present embodiment, the mode of the network configuration (redundancy of communication routes) is classified as in the following architecture examples 1 ((a) to (c)) or architecture examples 2 ((a) to (d)). Here, the edge MU (Edge MU) is an MU having a direct connection with the RU.

### Architecture Example 1

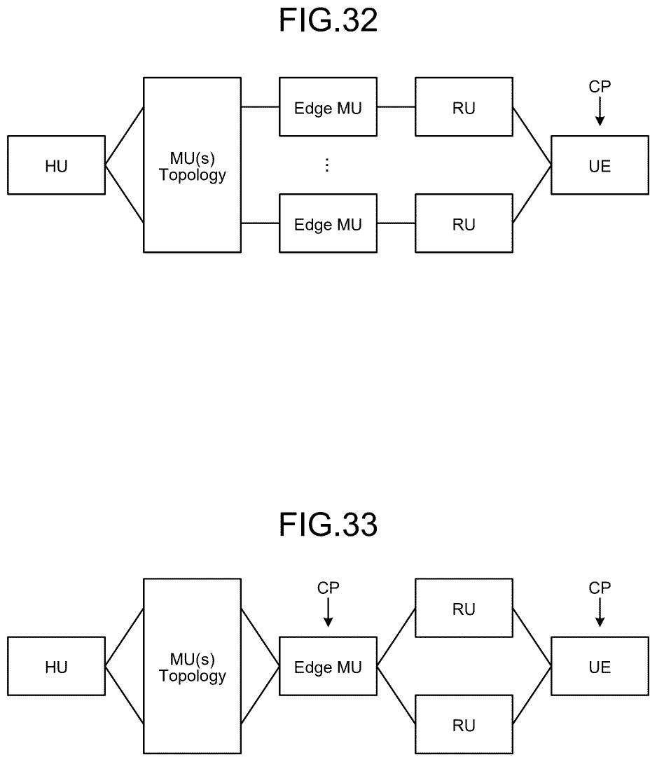

(a) Case where redundancy is closed between the HU and the edge MU and not closed at the RU or UE (for example, FIG. 30).
(b) Case where redundancy is closed between the HU and the RU and not closed at the UE (for example, FIG. 31).
(c) Case where redundancy is closed between the HU and the UE (for example, FIG. 32).

### Architecture Example 2

(a) Case where redundancy is closed between the HU and the edge MU and not closed at the RU or UE (for example, FIG. 30).
(b) Case where redundancy is closed between the HU and the RU and not closed at the UE (for example, FIG. 31).
(c) Case where redundancy is closed between the HU and the UE, and not the case of the following (d) (for example, FIG. 32).
(d) Case where redundancy is closed between the HU and the UE and redundancy is also closed from the HU to the edge MU (for example, FIG. 33).

Here, “redundancy is closed” indicates a state in which there are two or more different routes in the route connecting between two certain units, and at least the unit on the terminal side has connections with a plurality of units. In the examples of FIGS. 30 to 33, a portion indicated by CP is a point where redundancy is closed. Between units for which the redundancy is closed, redundancy between the same or another unit may be closed. Here, the unit includes a UE (terminal apparatus).

A problem to be solved in the second embodiment is inefficiency when a coding technique for improving reliability and achieving effective utilization of diversity using route redundancy is introduced into a communication system having such a communication architecture.

In particular, in the communication system adopting the mode described in architecture example 1 or architecture example 2, the point at which the redundancy is closed varies depending on the system. When considering a characteristic of packet coding in which a sufficient effect can be achieved when decoding is performed at a point where redundancy is closed, performing coding at a single point is not considered to be efficient.

That is, there is need to provide a procedure or signal processing capable of performing decoding at a highly effective point or capable of switching the decoding point as necessary, according to various types of route redundancy.

### Solution

When a configuration of a network connected to User Equipment (UE) is functionally split into a higher unit (HU), a middle unit (MU), and a radio unit (RU), the communication system of the second embodiment includes: a transmission apparatus corresponding to HU; and a reception apparatus corresponding to MU, RU, or UE.

An edge MU, which is an MU located closest to the RU, transmits, to a transmission apparatus (HU), information related to an RU that has a direct connection with the edge MU. The transmission apparatus acquires, from the edge MU, information on the RU having direct connection with the edge MU. Based on the information (information related to the RU) acquired from the edge MU the transmission apparatus determines information related to an architecture related to the edge MU, the RU, and the UE. Subsequently, the transmission apparatus generates a plurality of coded sequences from one transmission data sequence by using packet coding, and assigns information related to architecture to each of the plurality of coded sequences.

The reception apparatus (MU, RU, or UE) receives, from the transmission apparatus (HU), the coded sequence to which information related to architecture has been assigned. Subsequently, based on the information related to architecture assigned to the coded sequence. the reception apparatus determines whether the decoding processing is valid or invalid (whether the reception apparatus itself should perform decoding processing). When having determined that the decoding processing is valid, the reception apparatus decodes the plurality of coded sequences using a decoding method corresponding to packet coding.

### Effects

Since the information related to architecture is assigned to the coded sequence, the decoding processing can be performed by an appropriate device on the network. As a result, highly reliable and highly efficient communication can be performed by making the most of route redundancy. Furthermore, the switching of the decoding start point can be achieved with a small amount of information without greatly depending on the configuration of the network.

### 5-2. Operation of Communication System 1 of Second Embodiment

The overview of the second embodiment has been described above. Hereinafter, the operation of the communication system 1 of the second embodiment will be described.

In the following description, a device corresponding to the Higher Unit (HU) is referred to as a transmission apparatus. In the following description, a device corresponding to the Middle Unit (MU), the Radio Unit (RU), or User Equipment (UE) is referred to as a reception apparatus. The HU may be the server 10, the management apparatus 20, the base station 30, or partial functions of these apparatuses. The MU may be the management apparatus 20, the base station 30, or a partial function of these apparatuses. In addition, the UE may be the terminal apparatus 40.

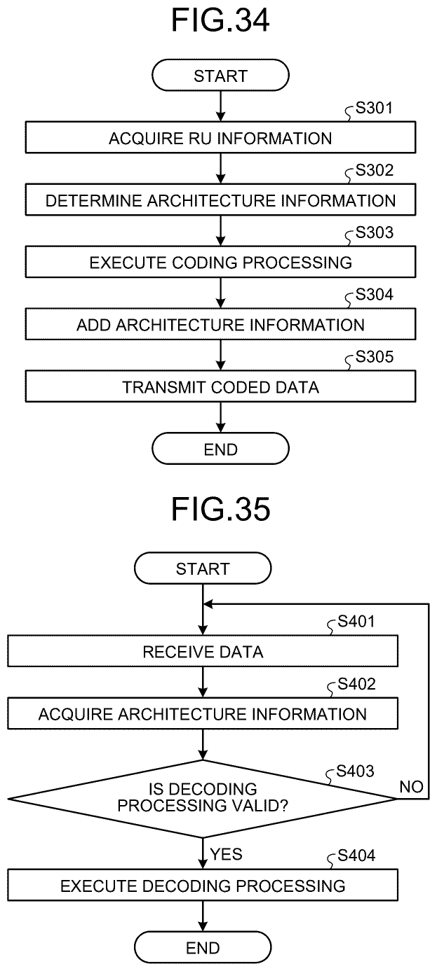

First, transmission processing will be described. FIG. 34 is a flowchart illustrating transmission processing according to a second embodiment. The transmission processing according to the second embodiment will be described below with reference to FIG. 34.

The edge MU notifies the transmission apparatus (HU) of information (hereinafter referred to as RU information) related to an RU having direct connection with the edge MU. Here, the edge MU is an MU having a direct connection with the RU. The transmission apparatus (HU) acquires RU information from the edge MU (step S301). The RU information may be notified on a physical channel or may be notified via a public general network. At this time, the RU information includes at least any one of the following pieces of information (1) to (2).
(1) Information for identifying the edge MU. This information is ID unique to the edge MU, for example.
(2) Information related to RU attached to the edge MU. This information is the number of RUs directly connected to the edge MU, for example. Alternatively, this information is information (for example, an RU-specific ID) for identifying an RU directly connected to the edge MU, for example.

The RU information is used to discern the quantity of generated coded sequences and architecture information attached to the coded sequences.

Next, the transmission apparatus (HU) determines architecture information based on the RU information (step S302). The architecture information is information related to architecture regarding the edge MU, the RU, and the UE. For example, the transmission apparatus determines information for specifying in which unit the redundancy of the communication route is closed, as the architecture information. This processing (architecture determination processing) includes, for example, the following processing (1) to (2).
(1) The transmission apparatus (HU) discerns the number of edge MUs to be used and the number of usable RUs based on the RU information acquired in step S301.
(2) The transmission apparatus categorizes the architecture information as the architecture examples (architecture example 1 or architecture example 2) from the discerning result of (1) above.

### Architecture Example 1

(a) Case where redundancy is closed between the HU and the edge MU and not closed at the RU or UE (for example, FIG. 30).
(b) Case where redundancy is closed between the HU and the RU and not closed at the UE (for example, FIG. 31).
(c) Case where redundancy is closed between the HU and the UE (for example, FIG. 32).

### Architecture Example 2

(a) Case where redundancy is closed between the HU and the edge MU and not closed at the RU or UE (for example, FIG. 30).
(b) Case where redundancy is closed between the HU and the RU and not closed at the UE (for example, FIG. 31).
(c) Case where redundancy is closed between the HU and the UE, and not the case of the following (d) (for example, FIG. 32).
(d) Case where redundancy is closed between the HU and the UE and redundancy is also closed from the HU to the edge MU (for example, FIG. 33).

At this time, when the number of edge MUs is one and the number of RUs is one, the transmission apparatus (HU) determines that the architecture corresponds to Case (a) above. When the edges MU is provided in plurality and one RU having the same identification number is attached the plurality of edge MUs, the transmission apparatus (HU) determines that the architecture corresponds to Case (b) above. When the edges MU is provided in plurality and an RU having mutually different identification number is attached to each of the plurality of edge MUs, the transmission apparatus (HU) determines that the architecture corresponds to Case (c) above. At this time, when the number of edge MUs is one and the RU is provided in plurality, the transmission apparatus (HU) determines that the architecture corresponds to Case (d) above.

Next, the transmission apparatus (HU) performs coding processing on the transmission data sequence (step S303). Specifically, the transmission apparatus performs packet coding processing on the transmission data sequence. The packet coding processing includes: a dividing procedure of dividing one transmission data sequence into a plurality of subsequences; and a generating procedure of applying coding processing according to a predetermined error correction coding scheme to the plurality of subsequences to generate a plurality of coded sequences from the plurality of subsequences.

Next, the transmission apparatus (HU) adds the architecture information determined in step S302 to the coded sequence as information bits (step S304). At this time, the transmission apparatus may assign the information bits indicating the architecture information to each of a plurality of coded sequences as a header, for example. In assignment to the architecture information, the transmission apparatus may assign an identification number of the edge MU or RU to be used. The information bit and the architecture may be associated as described below.

### Information Bit: Architecture Information

00: Case of (a) in architecture example 1/example 2 above
01: Case of in architecture example 1/example 2 above
10: Case of (c) in architecture example 1/example 2 above
11: Case of (d) in architecture example 2 above

Next, the transmission apparatus (HU) transmits the coded sequence to which the architecture information has been added to the terminal apparatus 40 (UE) (step S305). When completing the transmission, the transmission apparatus (HU) ends the transmission processing.

Next, the reception processing will be described. FIG. 35 is a flowchart illustrating reception processing according to the second embodiment. The reception processing according to the second embodiment will be described below with reference to FIG. 35.

The reception apparatus (MU, RU, or UE) acquires data (coded sequence) transmitted from the transmission apparatus (HU) via the network (step S401).

Subsequently, the reception apparatus (MU, RU, or UE) acquires architecture information from the received data (step S402). For example, the reception apparatus determines which one of 00, 01, 10, and 11 corresponds to the information bit added to the coded sequence. At this time, 00 corresponds to the case of (a) of the architecture example 1/example 2 above; 01 corresponds to the case of (b) of the architecture example 1/example 2 above; 10 corresponds to the case of (c) of the architecture example 1/example 2 above; and 11 corresponds to the case of (d) of the architecture example 2 above.

Subsequently, the reception apparatus (MU, RU, or UE) determines whether the decoding processing is valid (whether the reception apparatus itself should perform decoding processing) based on the acquired architecture information (step S403).

For example, the reception apparatus determines that the decoding processing is valid in a case where the information bit added to the coded sequence is 00 (case where the redundancy of the communication route corresponds to (a) above) and in a case where the reception apparatus itself corresponds to the edge MU.

For example, the reception apparatus determines that the decoding processing is valid in a case where the information bit added to the coded sequence is 01 (case where the redundancy of the communication route corresponds to the (b) above) and in a case where the reception apparatus corresponds to the edge MU or the UE, or in a case where the reception apparatus corresponds to the edge MU, the UE, or the RU. Alternatively, the reception apparatus may determine that the decoding processing is valid in a case where the information bit added to the coded sequence is 01 (case where the redundancy of the communication route corresponds to (b) above) and in a case where the reception apparatus itself corresponds to the edge MU. Alternatively, the reception apparatus may determine that the decoding processing is valid in a case where the information bit added to the coded sequence is 01 (case where the redundancy of the communication route corresponds to (b) above) and in a case where the reception apparatus itself corresponds to the UE. Alternatively, the reception apparatus may determine that the decoding processing is valid in a case where the information bit added to the coded sequence is 01 (case where the redundancy of the communication route corresponds to (b) above) and in a case where the reception apparatus itself corresponds to the RU.

For example, the reception apparatus determines that the decoding processing is valid in a case where the information bit added to the coded sequence is 10 (case where the redundancy of the communication route corresponds to (c) above) and in a case where the reception apparatus itself corresponds to the edge MU or UE. Alternatively, the reception apparatus may determine that the decoding processing is valid in a case where the information bit added to the coded sequence is 10 (case where the redundancy of the communication route corresponds to (c) above) and in a case where the reception apparatus itself corresponds to the edge MU. Alternatively, the reception apparatus may determine that the decoding processing is valid in a case where the information bit added to the coded sequence is 10 (case where the redundancy of the communication route corresponds to (c) above) and in a case where the reception apparatus itself corresponds to the UE.

For example, the reception apparatus determines that the decoding processing is valid in a case where the information bit added to the coded sequence is 11 (case where the redundancy of the communication route corresponds to (d) above) and in a case where the reception apparatus itself corresponds to the edge MU or UE. Alternatively, the reception apparatus may determine that the decoding processing is valid in a case where the information bit added to the coded sequence is 11 (case where the redundancy of the communication route corresponds to (d) above) and in a case where the reception apparatus itself corresponds to the edge MU. Alternatively, the reception apparatus may determine that the decoding processing is valid in a case where the information bit added to the coded sequence is 11 (case where the redundancy of the communication route corresponds to (d) above) and in a case where the reception apparatus itself corresponds to the UE.

When the decoding processing is not valid (step S403: No), the reception apparatus returns the processing to step S401.

When the decoding processing is valid (step S403:

Yes), the reception apparatus decodes a plurality of coded sequences using a decoding method corresponding to packet coding (step S404). At this point, the reception apparatus performs the following processing (1) to (4) for each information bit.
(1) When the information bit added to the coded sequence is 00 (when the redundancy of the communication route corresponds to (a) above), the reception apparatus (for example, the edge MU) performs the following processing.

For example, the edge MU starts decoding by using the delivered coded sequence. It is desirable to use a method that maximizes the effect in the upper layer coding such as using the start condition, for example, as a case where a predesignated number or more of coded sequences have been delivered at the edge MU.

When the decoding is successful, it is desirable that the edge MU performs signal processing predefined in a standard or the like to perform transmission to the reception side. When the decoding has resulted in failure, the edge MU may attempt decoding again using the additionally delivered coded sequence. When the decoding has resulted in failure, the edge MU may notify any upper level of the failure of the decoding. The upper function, the upper protocol, or the upper layer that has received this notification may judge whether to perform additional transmission based on this result.

The decoding may be processed in any protocol stack of the edge MU. Furthermore, decoding may be performed by a function of a region different from the edge MU.
(2) When the information bit added to the coded sequence is 01 (when the redundancy of the communication route corresponds to (b) above), the reception apparatus (for example, the edge MU, RU or UE) performs the following processing.

Each edge MU recognizes the number of edge MUs used in communication based on the notification from the HU. Each edge MU performs configuration such as a transport block size by using a value obtained by dividing a throughput usable for transmission at the RU by the number of edge MUs, that is, a throughput amount that can be handled by each edge MU. This operation is an operation necessary for each edge MU to cooperatively perform adaptive signal processing on the throughput determined by the capability of the RU and the transmission method. All the functions of the MU may be configured as necessary.

The plurality of transmission sequences including the coded sequence processed by the edge MU may be subjected to any of the following processing in the RU:
At RU, a plurality of transmission sequences is combined as one transmission sequence to be transmitted to the UE. Although this is a method capable of achieving high resource efficiency on the time axis while making the most of the transmission capability of the RU, this method needs combining processing.
The RU performs transmission processing individually on a transmission unit from each edge MU. This method needs no combining processing but has a possibility of occurrence of transmission delays.
The RU performs decoding processing by using the transmission sequence. The diversity on the transmission side can be utilized without performing decoding processing on the reception side. If this option is not selected, the decoding processing would be performed on the receiving side. After the decoding processing, the RU performs transmission processing using the decoded sequence as a transmission sequence.

When decoding processing is performed in the UE, the UE desirably acquires at least minimum information (start condition) that can be decoded from the transmission side or the received packet. It is desirable to use a method that maximizes the effect in the upper layer coding such as setting the start condition for decoding, for example, as a case where coded sequences of a predesignated number coded packets or more have been delivered.

When the decoding is successful, it is desirable that the edge reception apparatus performs signal processing predefined in a standard or the like to perform transmission to the upper level. When the decoding has resulted in failure, the reception apparatus may attempt decoding again using the additionally delivered coded sequence. When the decoding has resulted in failure, the reception apparatus may notify any upper level of the failure of the decoding. The upper function, the upper protocol, or the upper layer that has received this notification may judge whether to perform additional transmission based on this result.

The decoding may be performed in a protocol stack of either the edge MU or the UE. Furthermore, decoding may be performed by a function of a region different from the edge MU. At this time, the decoding function may be diverted from the outside.
(3) When the information bit added to the coded sequence is 10 (when the redundancy of the communication route corresponds to (c) above), the reception apparatus (for example, the edge MU or UE) performs the following processing.

The decoding processing is desirably performed by the UE. When decoding processing is performed in the UE, the UE desirably acquires at least minimum information (start condition) that can be decoded from the transmission side or the received packet. It is desirable to use a method that maximizes the effect in the upper layer coding such as setting the start condition, for example, as a case where coded sequences of a predesignated number coded packets or more have been delivered to the reception side.

In a case where the decoding is successful, the reception apparatus may perform signal processing predefined in a standard or the like. In a case where the decoding that is desirably transmitted to an upper level has resulted in failure, the reception apparatus may reattempt to perform decoding using an additionally delivered coded sequence. When the decoding has resulted in failure, the reception apparatus may notify any upper level of the failure of the decoding. The upper function, the upper protocol, or the upper layer that has received this notification may judge whether to perform additional transmission based on this result.

The decoding may be performed in one protocol stack of the UE. Furthermore, decoding may be performed by a function of a region different from the UE. At this time, the decoding function may be diverted from the outside.
(4) When the information bit added to the coded sequence is 11 (when the redundancy of the communication route corresponds to (d) above), the reception apparatus (for example, the edge MU or UE) performs the following processing.

The edge MU may perform one or both of the following processing 1 and processing 2.

### Processing 1

Until the decoding processing, the reception apparatus performs the same processing as the case where the information bit is 00 (the case where the redundancy of the communication route corresponds to (a) above). For example, the edge MU starts decoding by using the delivered coded sequence.

After decoding, there are two more options.

### Option 1

The edge MU newly performs coding (upper layer FEC) using the decoded sequence to generate a plurality of new coded sequences. The edge MU sends a plurality of newly generated coded sequences to RUs in a distributed manner. The edge MU performs FEC suitable for the number and state of RUs, and can efficiently use diversity by the RU, leading to further improvement of that communication efficiency. The decoding processing is desirably performed on the reception side. The processing may be the same as that in the case where the information bit is 01 (the case where the redundancy of the communication route corresponds to (b) above).

### Option 2

The edge MU transmits the transmission sequence to the RU by a method other than new coding. For example, the edge MU may perform transmission using duplication or HARQ. Compared with the option 1, this method is difficult to efficiently utilize the diversity of the RU, but simplifies signal processing.

These options may be determined based on at least one of information notified from an upper layer, channel information, information related to a state of a link, static information, semi-static information, header information of a coded sequence, and dynamic information.

### Processing 2

The edge MU redistributes the coded sequence to the RU without performing decoding processing. It is desirable that the redistribution is adaptively performed according to the number of RUs accompanying the edge MU, a resource amount at a physical layer level, and/or a channel state. The redistributed coded sequence undergoes decoding processing at the UE. The processing may be the same as that in the case where the information bit is 01 (the case where the redundancy of the communication route corresponds to (b) above). Processing 2 has reduced decoding processing as compared with processing 1, leading to reduction of processing delays.

When decoding processing is performed in the UE, the UE desirably acquires at least minimum information that can be decoded from the transmission side or the received packet. It is desirable to use a method that maximizes the effect in the upper layer coding such as setting the start condition, for example, as a case where coded sequences of a predesignated number coded packets or more have been delivered to the edge MU.

In a case where the decoding is successful, the reception apparatus may perform signal processing predefined in a standard or the like. In a case where the decoding that is desirably transmitted to an upper level has resulted in failure, the reception apparatus may reattempt to perform decoding using an additionally delivered coded sequence. When the decoding has resulted in failure, the reception apparatus may notify any upper level of the failure of the decoding. The upper function, the upper protocol, or the upper layer that has received this notification may judge whether to perform additional transmission based on this result.

The decoding may be performed in a protocol stack of either the edge MU or the UE. Furthermore, decoding may be performed by a function of an area different from the edge MU or the UE. At this time, the decoding function may be diverted from the outside.

When completing the decoding, the reception apparatus ends the reception processing.

According to the second embodiment, the communication system 1 of the second embodiment can perform decoding processing by an appropriate apparatus on the network, making it possible to improve communication efficiency or communication reliability.

### 6. Modification

The above-described embodiment is an example, and various modifications and applications are possible.

For example, the second embodiment has described that the data (one or a plurality of coded sequences) is transmitted from the HU to the UE, but the data may be transmitted from the HU to the terminal apparatus 40 other than the UE. In this case, the description of the UE described above can be replaced with the terminal apparatus 40.

The description of the transmission apparatus of the above-described embodiment (first and second embodiments) can be replaced with the server 10, the management apparatus 20, the base station 30, or the terminal apparatus 40 as appropriate.

Furthermore, the description of the reception apparatus can be replaced with the server 10, the management apparatus 20, the base station 30, or the terminal apparatus 40 as appropriate.

A control apparatus that controls the server 10, the management apparatus 20, the base station 30, and the terminal apparatus 40 of the present embodiment may be actualized by a dedicated computer system or a general-purpose computer system.

For example, a communication program for executing the above-described operations is stored in a computer-readable recording medium such as an optical disk, semiconductor memory, a magnetic tape, or a flexible disk and distributed. For example, the program is installed on a computer and the above processing is executed to achieve the configuration of the control apparatus. At this time, the control apparatus may be an apparatus (for example, a personal computer) external to the server 10, the management apparatus 20, the base station 30, or the terminal apparatus 40. Furthermore, the control apparatus may be an apparatus (for example, the control unit 13, the control unit 23, the control unit 33, or the control unit 43) inside the server 10, the management apparatus 20, the base station 30, or the terminal apparatus 40.

Furthermore, the communication program can be stored in a disk device included in a server apparatus on a network such as the Internet so as to be able to be downloaded to a computer, for example. Furthermore, the functions described above may be implemented by using operating system (OS) and application software in cooperation. In this case, the portions other than the OS may be stored in a medium for distribution, or the portions other than the OS may be stored in a server device so as to be downloaded to a computer, for example.

Furthermore, among individual processing described in the above embodiments, all or a part of the processing described as being performed automatically may be manually performed, or the processing described as being performed manually can be performed automatically by known methods. In addition, the processing procedures, specific names, and information including various data and parameters illustrated in the above Literatures or drawings can be arbitrarily altered unless otherwise specified. For example, a variety of information illustrated in each of the drawings are not limited to the information illustrated.

In addition, each of components of each device is provided as a functional and conceptional illustration and thus does not necessarily need to be physically configured as illustrated. That is, the specific mode of distribution/integration of each of the devices is not limited to those illustrated in the drawings, and all or a part thereof may be functionally or physically distributed or integrated into arbitrary units according to various loads and use situations. This configuration by distribution and integration may be performed dynamically.

Furthermore, the above-described embodiments can be appropriately combined within a range implementable without contradiction of processing. Furthermore, the order of individual steps illustrated in the flowcharts of the above-described embodiment can be changed as appropriate.

Furthermore, for example, the present embodiment can be implemented as any configuration constituting a device or a system, for example, a processor as a large scale integration (LSI) or the like, a module using a plurality of processors or the like, a unit using a plurality of modules or the like, and a set obtained by further adding other functions to the unit, or the like (that is, a configuration of a part of the device).

In the present embodiment, a system represents a set of a plurality of components (devices, modules (parts), or the like), and whether all the components are in the same housing would not be a big issue. Therefore, a plurality of apparatuses or devices housed in separate housings and connected via a network, and one apparatus or device in which a plurality of modules are housed in one housing, are both systems.

Furthermore, for example, the present embodiment can adopt a configuration of cloud computing in which one function is cooperatively shared and processed by a plurality of apparatuses or devices via a network.

### 7. Conclusion

As described above, the communication system 1 according to the first embodiment includes a transmission apparatus (for example, the base station 30) capable of performing communication by multi-TRP and a reception apparatus (for example, the terminal apparatus 40) capable of performing communication by multi-TRP.

The transmission apparatus multiplexes a plurality of upper layer packets to generate one transmission data sequence. Subsequently, the transmission apparatus generates a plurality of coded sequences from one transmission data sequence by using packet coding. At this time, the packet coding processing includes: a procedure of dividing one transmission data sequence into a plurality of subsequences; and a procedure of applying coding processing according to a predetermined error correction coding scheme to the plurality of subsequences to generate a plurality of coded sequences from the plurality of subsequences. The transmission apparatus distributes the plurality of coded sequences for each TRP based on the information of the transport block size of each of the plurality of TRPs. Subsequently, the transmission apparatus generates a transport block of each of the plurality of TRPs based on the distributed coded sequence.

The reception apparatus receives a plurality of transport blocks from the transmission apparatus. Subsequently, the reception apparatus extracts a plurality of coded sequences from each of the plurality of transport blocks. The reception apparatus decodes the plurality of extracted coded sequences using a decoding method corresponding to packet coding. Subsequently, the reception apparatus separates the decoded data into a plurality of upper layer packets.

This makes it possible for the communication system of the first embodiment to cope with a case where the transport block size is different for each transmission and reception point. As a result, the communication system 1 can improve efficiency and flexibility in achieving communication reliability.

When a configuration of a network connected to User Equipment (UE) is functionally split into a higher unit (HU), a middle unit (MU), and a radio unit (RU), the communication system 1 according to the second embodiment includes: a transmission apparatus corresponding to HU; and a reception apparatus corresponding to MU, RU, or UE.

An edge MU, which is an MU located closest to the RU, transmits, to a transmission apparatus (HU), information related to an RU that has a direct connection with the edge MU. The transmission apparatus acquires, from the edge MU, information on the RU having direct connection with the edge MU. Based on the information (information related to the RU) acquired from the edge MU the transmission apparatus determines information related to an architecture related to the edge MU, the RU, and the UE. Subsequently, the transmission apparatus generates a plurality of coded sequences from one transmission data sequence by using packet coding, and assigns information related to architecture to each of the plurality of coded sequences.

The reception apparatus (MU, RU, or UE) receives, from the transmission apparatus (HU), the coded sequence to which information related to architecture has been assigned. Subsequently, based on the information related to architecture assigned to the coded sequence. the reception apparatus determines whether the decoding processing is valid or invalid (whether the reception apparatus itself should perform decoding processing). When having determined that the decoding processing is valid, the reception apparatus decodes the plurality of coded sequences using a decoding method corresponding to packet coding.

With this configuration, the communication system 1 of the second embodiment can perform decoding processing by an appropriate apparatus on the network, making it possible to improve communication efficiency or communication reliability.

The embodiments of the present disclosure have been described above. However, the technical scope of the present disclosure is not limited to the above-described embodiments, and various modifications can be made without departing from the scope of the present disclosure. Moreover, it is allowable to combine the components across different embodiments and modifications as appropriate.

The effects described in individual embodiments of the present specification are merely examples, and thus, there may be other effects, not limited to the exemplified effects.

Note that the present technology can also have the following configurations.
(1)
   A communication apparatus capable of performing communication using a plurality of transmission and reception points, the communication apparatus including:
   a coder that generates a plurality of coded sequences from one transmission data sequence by using packet coding; and
   a generator that distributes the plurality of coded sequences for each transmission and reception point based on transport block size information of each of the plurality of transmission and reception points, and generate a transport block of each of the plurality of transmission and reception points based on the distributed coded sequence.
(2)
   The communication apparatus according to (1), further including
   a multiplexer that multiplexes a plurality of packets to generates the one transmission data sequence.
(3)
   The communication apparatus according to (2), in which
   the multiplexer determines a size of the one transmission data sequence based on information related to communication, and multiplexes the plurality of packets so as to obtain the determined size.
(4)
   The communication apparatus according to (3), in which
   the multiplexer determines the size of the one transmission data sequence based on the transport block size information of each of the plurality of transmission and reception points.
(5)
   The communication apparatus according to (3), in which
   the multiplexer determines a largest size among a plurality of transport block sizes as a size of the one transmission data sequence.
(6)
   The communication apparatus according to any of (1) to (5), in which
   processing of the packet coding includes: a procedure of dividing the one transmission data sequence into a plurality of subsequences; and a procedure of applying coding processing according to a predetermined error correction coding scheme to the plurality of subsequences to generate the plurality of coded sequences from the plurality of subsequences.
(7)
   The communication apparatus according to (6), in which
   the coder determines number of divisions of the one transmission data sequence according to a predetermined condition, and divides the one transmission data sequence into the plurality of subsequences so as to obtain the determined number of divisions.
(8)
   The communication apparatus according to (7), in which
   the coder determines the number of divisions of the one transmission data sequence based on reliability information required in transmitting the transmission data sequence.
(9)
   The communication apparatus according to (7), in which
   the coder determines the number of divisions of the one transmission data sequence based on a notification from another communication apparatus.
(10)
   The communication apparatus according to (7), in which
   the coder determines the number of divisions of the one transmission data sequence based on number of usable transmission and reception points.
(11)
   The communication apparatus according to (7), in which
   the coder determines the number of divisions of the one transmission data sequence based on the transport block size information.
(12)
   The communication apparatus according to (11), in which
   the coder determines the number of divisions of the one transmission data sequence based on information of common divisors of a plurality of transport block sizes.
(13)
   The communication apparatus according to (7), in which
   the generator determines the number of divisions of the one transmission data sequence based on a state of a physical layer of a channel used for transmission of the transmission data sequence.
(14)
   The communication apparatus according to any of (6) to (13), in which
   the predetermined error correction coding scheme includes at least one of erasure codes, rateless codes, fountain codes, Tornado codes, Luby Transform (LT) codes, Raptor codes, RaptorQ codes, Low Density Parity Check (LDPC) codes, BCH cods, Reed Solomon (RS) codes, and exclusive OR (XOR) codes.
(15)
   A communication apparatus capable of performing communication using a plurality of transmission and reception points, the communication apparatus including:
   a receiver that generates a plurality of coded sequences from one transmission data sequence using packet coding, distributes the plurality of coded sequences for each transmission and reception point based on transport block size information of each of the plurality of transmission and reception points, and receives a plurality of transport blocks from another communication apparatus that generates transport blocks of each of the plurality of transmission and reception points based on the distributed coded sequences; and
   a decoder that decodes, using a decoding method corresponding to the packet coding, the plurality of coded sequences extracted from the plurality of transport blocks.
(16)
   The communication apparatus according to (15), in which
   the decoder starts decoding the plurality of coded sequences at a timing of receiving the coded sequences of a quantity or a length satisfying a predetermined criterion.
(17)
   The communication apparatus according to (15), in which
   the decoder starts decoding the plurality of coded sequences at a timing when a set timer satisfies a predetermined criterion.
(18)
   A communication method implemented by a communication apparatus capable of performing communication using a plurality of transmission and reception points, the communication method including:
   generating a plurality of coded sequences from one transmission data sequence by using packet coding; and
   distributing the plurality of coded sequences for each transmission and reception point based on transport block size information of each of the plurality of transmission and reception points, and generating a transport block of each of the plurality of transmission and reception points based on the distributed coded sequence.
(19)
   A communication method implemented by a communication apparatus capable of performing communication using a plurality of transmission and reception points, the communication method including:
   generating a plurality of coded sequences from one transmission data sequence using packet coding, distributing the plurality of coded sequences for each transmission and reception point based on transport block size information of each of the plurality of transmission and reception points, and receiving a plurality of transport blocks from another communication apparatus that generates transport blocks of each of the plurality of transmission and reception points based on the distributed coded sequences; and
   decoding, using a decoding method corresponding to the packet coding, the plurality of coded sequences extracted from the plurality of transport blocks.
(20)
   A communication system including: a first communication apparatus capable of performing communication using a plurality of transmission and reception points; and a second communication apparatus capable of performing communication using the plurality of transmission and reception points, in which
   the first communication apparatus includes:
   a coder that generates a plurality of coded sequences from one transmission data sequence using packet coding; and
   a generator that distributes the plurality of coded sequences for each transmission and reception point based on transport block size information of each of the plurality of transmission and reception points, and generates transport blocks of each of the plurality of transmission and reception points based on the distributed coded sequences, and
   the second communication apparatus includes:
   a receiver that receives a plurality of transport blocks from the first communication apparatus; and
   a decoder that decodes, using a decoding method corresponding to the packet coding, the plurality of coded sequences extracted from the plurality of transport blocks.
(21)
   A communication apparatus corresponding to a Higher Unit (HU), when a configuration of a network connected to User Equipment (UE) is functionally split into the HU, a Radio Unit (RU), and a Middle Unit (MU), the HU indicating a unit of a highest layer, the RU indicating a unit of a lowest layer, the MU indicating a unit located between the HU and the RU, the communication apparatus including:
   an acquisition unit that acquires, from an edge MU that is the MU located closest to the RU, information related to an RU having direct connection with the edge MU;
   a determiner that determines information related to architecture regarding the edge MU, the RU, and the UE based on the information related to the RU acquired from the edge MU;
   a coder that generates a plurality of coded sequences from one transmission data sequence by using packet coding; and
   an assignment unit that assigns the information related to architecture to the plurality of coded sequences.
(22)
   The communication apparatus according to (21), in which
   the determiner determines information for specifying in which unit redundancy of a communication route is closed, as the information related to architecture.
(23)
   The communication apparatus according to (22), in which
   the information related to architecture determined by the determiner includes information indicating which of the following cases (a) to (c) corresponds to the redundancy of the communication route:
   (a) Case where the redundancy is closed between the HU and the edge MU and is not closed at the RU or the UE;
   (b) Case where the redundancy is closed between the HU and the RU and is not closed at a terminal; or
   (c) Case where the redundancy is closed between the HU and the UE.
(24)
   The communication apparatus according to (22), in which
   the information related to architecture determined by the determiner includes information indicating which of the following cases (a) to (d) corresponds to the redundancy of the communication route:
   (a) Case where the redundancy is closed between the HU and the edge MU and is not closed at the RU or the UE;
   (b) Case where the redundancy is closed between the HU and the RU and is not closed at a terminal;
   (c) Case where the redundancy is closed between the HU and the UE, and not the case of following (d); or
   (d) Case where the redundancy is closed between the HU and the UE and redundancy is also closed from the HU to the edge MU.
(25)
   The communication apparatus according to any of (21) to (24), in which
   processing of the packet coding includes: a procedure of dividing the one transmission data sequence into a plurality of subsequences; and a procedure of applying coding processing according to a predetermined error correction coding scheme to the plurality of subsequences to generate the plurality of coded sequences from the plurality of subsequences.
(26)
   The communication apparatus according to (25), in which
   the predetermined error correction coding scheme includes at least one of erasure codes, rateless codes, fountain codes, Tornado codes, Luby Transform (LT) codes, Raptor codes, RaptorQ codes, Low Density Parity Check (LDPC) codes, BCH codes, Reed Solomon (RS) codes, and exclusive OR (XOR) codes.
(27)
   A communication apparatus corresponding to a Middle Unit (MU), a Radio Unit (RU) or User Equipment (UE) when a configuration of a network connected to the UE is functionally split into a Higher Unit (HU), the RU and the MU, the HU indicating a unit of a highest layer, the RU indicating a unit of a lowest layer, the MU indicating a unit located between the HU and the RU, the communication apparatus including:
   a receiver that receives, from the HU that generates a plurality of coded sequences from one transmission data sequence by using packet coding, the coded sequence to which information related to architecture regarding an edge MU, the RU, and the UE has been assigned;
   a determiner that determines whether decoding processing is valid or invalid based on the information related to architecture assigned to the coded sequence; and
   a decoder that decodes the plurality of coded sequences using a decoding method corresponding to the packet coding, in a case where the decoding processing is determined to be valid.
(28)
   The communication apparatus according to (27), in which
   the information related to architecture includes information for specifying in which unit redundancy of a communication route is closed.
(29)
   The communication apparatus according to (28), in which
   the information related to architecture includes information indicating which of the following cases (a) to (d) corresponds to the redundancy of the communication route:
   (a) Case where the redundancy is closed between the HU and the edge MU and is not closed at the RU or the UE;
   (b) Case where the redundancy is closed between the HU and the RU and is not closed at the UE;
   (c) Case where the redundancy is closed between the HU and the UE, and not the case of following (d); or
   (d) Case where the redundancy is closed between the HU and the UE and redundancy is also closed from the HU to the edge MU.
(30)
   The communication apparatus according to (28), in which
   the information related to architecture includes information indicating which of the following cases (a) to (c) corresponds to the redundancy of the communication route:
   (a) Case where the redundancy is closed between the HU and the edge MU and is not closed at the RU or the UE;
   (b) Case where the redundancy is closed between the HU and the RU and is not closed at the UE; or
   (c) Case where the redundancy is closed between the HU and the UE.
(31)
   The communication apparatus according to (29) or (30), in which
   the determiner determines that the decoding processing is valid when the redundancy of the communication route corresponds to the (a) and the apparatus itself corresponds to the edge MU.
(32)
   The communication apparatus according to (29) or (30), in which
   the determiner determines that the decoding processing is valid when the redundancy of the communication route corresponds to the (b) and the apparatus itself corresponds to the edge MU or the UE.
(33)
   The communication apparatus according to (29) or (30), in which
   the determiner determines that the decoding processing is valid when the redundancy of the communication route corresponds to the (b) and the apparatus itself corresponds to the RU.
(34)
   The communication apparatus according to (29) or (30), in which
   the determiner determines that the decoding processing is valid when the redundancy of the communication route corresponds to the (c) and the apparatus itself corresponds to the edge MU or the UE.
(35)
   The communication apparatus according to (29) or (30), in which
   the determiner determines that the decoding processing is valid when the redundancy of the communication route corresponds to the (c) and the apparatus itself corresponds to the UE.
(36)
   The communication apparatus according to (29), in which
   the determiner determines that the decoding processing is valid when the redundancy of the communication route corresponds to the (d) and the apparatus itself corresponds to the edge MU or the UE.
(37)
   The communication apparatus according to (36), in which,
   when the redundancy of the communication route corresponds to the (d) and the apparatus itself corresponds to the edge MU, the decoder decodes the plurality of coded sequences using the decoding method corresponding to the packet coding, and then uses the decoded sequences to newly generate a plurality of new coded sequences to be distributed and transmitted to a plurality of RUS.
(38)
   A communication method implemented by a communication apparatus corresponding to a Higher Unit (HU), when a configuration of a network connected to User Equipment (UE) is functionally split into the HU, a Radio Unit (RU), and a Middle Unit (MU), the HU indicating a unit of a highest layer, the RU indicating a unit of a lowest layer, the MU indicating a unit located between the HU and the RU, the communication method including:
   acquiring, from an edge MU that is the MU located closest to the RU, information related to an RU having direct connection with the edge MU;
   determining information related to architecture regarding the edge MU, the RU, and the UE based on the information related to the RU acquired from the edge MU;
   generating a plurality of coded sequences from one transmission data sequence by using packet coding; and
   assigning the information related to architecture to the plurality of coded sequences.
(39)
   A communication method implemented by a communication apparatus corresponding to a Middle Unit (MU), a Radio Unit (RU) or User Equipment (UE) when a configuration of a network connected to the UE is functionally split into a Higher Unit (HU), the RU and the MU, the HU indicating a unit of a highest layer, the RU indicating a unit of a lowest layer, the MU indicating a unit located between the HU and the RU, the communication method including:
   receiving, from the HU that generates a plurality of coded sequences from one transmission data sequence by using packet coding, the coded sequence to which information related to architecture regarding an edge MU, the RU, and the UE has been assigned;
   determining whether decoding processing is valid or invalid based on the information related to architecture assigned to the coded sequence; and
   decoding the plurality of coded sequences using a decoding method corresponding to the packet coding in a case where the decoding processing is determined to be valid.
(40)
   A communication system including: a first communication apparatus corresponding to a Higher Unit (HU), when a configuration of a network connected to User Equipment (UE) is functionally split into the HU, a Radio Unit (RU), and a Middle Unit (MU), the HU indicating a unit of a highest layer, the RU indicating a unit of a lowest layer, the MU indicating a unit located between the HU and the RU; and a second communication apparatus corresponding to the MU, the RU, or the UE, in which
   the first communication apparatus includes:
   an acquisition unit that acquires, from an edge MU that is the MU located closest to the RU, information related to an RU having direct connection with the edge MU;
   a first determiner that determines information related to architecture regarding the edge MU, the RU, and the UE based on the information related to the RU acquired from the edge MU;
   a coder that generates a plurality of coded sequences from one transmission data sequence by using packet coding; and
   an assignment unit that assigns the information related to architecture to the plurality of coded sequences, and
   the second communication apparatus includes:
   a receiver that receives, from the first communication apparatus, the coded sequences to which the information related to architecture has been assigned;
a second determiner that determines whether decoding processing is valid or invalid based on the information related to architecture assigned to the coded sequence; and
   a decoder that decodes the plurality of coded sequences using a decoding method corresponding to the packet coding in a case where the decoding processing is determined to be valid.

### REFERENCE SIGNS LIST

1 COMMUNICATION SYSTEM
10 SERVER
20 MANAGEMENT APPARATUS
30 BASE STATION
40 TERMINAL APPARATUS
11, 21 COMMUNICATION UNIT
31, 41 WIRELESS COMMUNICATION UNIT
12, 22, 32, 42 STORAGE UNIT
13, 23, 33, 43 CONTROL UNIT
311, 411 TRANSMISSION PROCESSING UNIT
312, 412 RECEPTION PROCESSING UNIT
313, 413 ANTENNA
131, 331, 431 ACQUISITION UNIT
132, 336, 436 DETERMINER
133 ASSIGNMENT UNIT
332, 432 MULTIPLEXER
333, 433 CODER
334, 434 GENERATOR
335, 435 RECEIVER
337, 437 DECODER

1. A communication apparatus capable of performing communication using a plurality of transmission and reception points, the communication apparatus comprising:
a coder that generates a plurality of coded sequences from one transmission data sequence by using packet coding; and
a generator that distributes the plurality of coded sequences for each transmission and reception point based on transport block size information of each of the plurality of transmission and reception points, and generate a transport block of each of the plurality of transmission and reception points based on the distributed coded sequence.

2. The communication apparatus according to claim 1, further comprising
a multiplexer that multiplexes a plurality of packets to generates the one transmission data sequence.

3. The communication apparatus according to claim 2, wherein
the multiplexer determines a size of the one transmission data sequence based on information related to communication, and multiplexes the plurality of packets so as to obtain the determined size.

4. The communication apparatus according to claim 3, wherein
the multiplexer determines the size of the one transmission data sequence based on the transport block size information of each of the plurality of transmission and reception points.

5. The communication apparatus according to claim 3, wherein
the multiplexer determines a largest size among a plurality of transport block sizes as a size of the one transmission data sequence.

6. The communication apparatus according to claim 1, wherein
processing of the packet coding includes: a procedure of dividing the one transmission data sequence into a plurality of subsequences; and a procedure of applying coding processing according to a predetermined error correction coding scheme to the plurality of subsequences to generate the plurality of coded sequences from the plurality of subsequences.

7. The communication apparatus according to claim 6, wherein
the coder determines number of divisions of the one transmission data sequence according to a predetermined condition, and divides the one transmission data sequence into the plurality of subsequences so as to obtain the determined number of divisions.

8. The communication apparatus according to claim 7, wherein
the coder determines the number of divisions of the one transmission data sequence based on reliability information required in transmitting the transmission data sequence.

9. The communication apparatus according to claim 7, wherein
the coder determines the number of divisions of the one transmission data sequence based on a notification from another communication apparatus.

10. The communication apparatus according to claim 7, wherein
the coder determines the number of divisions of the one transmission data sequence based on number of usable transmission and reception points.

11. The communication apparatus according to claim 7, wherein
the coder determines the number of divisions of the one transmission data sequence based on the transport block size information.

12. The communication apparatus according to claim 11, wherein
the coder determines the number of divisions of the one transmission data sequence based on information of common divisors of a plurality of transport block sizes.

13. The communication apparatus according to claim 7, wherein
the generator determines the number of divisions of the one transmission data sequence based on a state of a physical layer of a channel used for transmission of the transmission data sequence.

14. The communication apparatus according to claim 6, wherein
the predetermined error correction coding scheme includes at least one of erasure codes, rateless codes, fountain codes, Tornado codes, Luby Transform (LT) codes, Raptor codes, RaptorQ codes, Low Density Parity Check (LDPC) codes, BCH cods, Reed Solomon (RS) codes, and exclusive OR (XOR) codes.

15. A communication apparatus capable of performing communication using a plurality of transmission and reception points, the communication apparatus comprising:
a receiver that generates a plurality of coded sequences from one transmission data sequence using packet coding, distributes the plurality of coded sequences for each transmission and reception point based on transport block size information of each of the plurality of transmission and reception points, and receives a plurality of transport blocks from another communication apparatus that generates transport blocks of each of the plurality of transmission and reception points based on the distributed coded sequences; and
a decoder that decodes, using a decoding method corresponding to the packet coding, the plurality of coded sequences extracted from the plurality of transport blocks.

16. The communication apparatus according to claim 15, wherein
the decoder starts decoding the plurality of coded sequences at a timing of receiving the coded sequences of a quantity or a length satisfying a predetermined criterion.

17. The communication apparatus according to claim 15, wherein
the decoder starts decoding the plurality of coded sequences at a timing when a set timer satisfies a predetermined criterion.

18. A communication method implemented by a communication apparatus capable of performing communication using a plurality of transmission and reception points, the communication method comprising:
generating a plurality of coded sequences from one transmission data sequence by using packet coding; and
distributing the plurality of coded sequences for each transmission and reception point based on transport block size information of each of the plurality of transmission and reception points, and generating a transport block of each of the plurality of transmission and reception points based on the distributed coded sequence.

19. A communication method implemented by a communication apparatus capable of performing communication using a plurality of transmission and reception points, the communication method comprising:
generating a plurality of coded sequences from one transmission data sequence using packet coding, distributing the plurality of coded sequences for each transmission and reception point based on transport block size information of each of the plurality of transmission and reception points, and receiving a plurality of transport blocks from another communication apparatus that generates transport blocks of each of the plurality of transmission and reception points based on the distributed coded sequences; and
decoding, using a decoding method corresponding to the packet coding, the plurality of coded sequences extracted from the plurality of transport blocks.

20. A communication system comprising: a first communication apparatus capable of performing communication using a plurality of transmission and reception points; and a second communication apparatus capable of performing communication using the plurality of transmission and reception points, wherein
the first communication apparatus includes:
a coder that generates a plurality of coded sequences from one transmission data sequence using packet coding; and
a generator that distributes the plurality of coded sequences for each transmission and reception point based on transport block size information of each of the plurality of transmission and reception points, and generates transport blocks of each of the plurality of transmission and reception points based on the distributed coded sequences, and
the second communication apparatus includes:
a receiver that receives a plurality of transport blocks from the first communication apparatus; and
a decoder that decodes, using a decoding method corresponding to the packet coding, the plurality of coded sequences extracted from the plurality of transport blocks.
